(19) United States
(12) Patent Application Publication
(10) Pub. No.: US 2025/0245514 A1
(43) Pub. Date: Jul. 31, 2025

(54) METHOD AND SYSTEM FOR TRAINING AN IMPLICIT NEURAL REPRESENTATION NETWORK TO PERFORM TIME SERIES DATA FORECASTING

(71) Applicant: Royal Bank of Canada, Toronto (CA)

(72) Inventors: Martin MAGILL, Whitby (CA); Alexander PASHEVICH, Vancouver (CA); Yik Chau Y. LUI, Toronto (CA); Mahdi GILANY, Kingston (CA); Chandramouli Shama SASTRY, Halifax (CA)

(21) Appl. No.: 19/043,128

(22) Filed: Jan. 31, 2025

Related U.S. Application Data
(60) Provisional application No. 63/627,577, filed on Jan. 31, 2024.

(51) Int. Cl. G06N 3/09; G06N 3/048

(52) U.S. Cl. CPC G06N 3/09; G06N 3/048

(57) ABSTRACT

Methods, systems, and techniques for training an implicit neural representation (INR) network to perform time series data forecasting. Lookback and horizon time series of data are obtained, with the lookback time series of data spanning a lookback time window and the horizon time series of data spanning a horizon time window following the lookback time window. A lookback basis and a horizon basis are determined by processing the lookback time series of data using the INR network. Weight and bias parameters are determined using a regression based on the lookback basis and time series. Predicted horizon values are forecast from the horizon basis values and the weight and bias parameters. The INR network is trained to reduce forecast error between the horizon time series of data and the predicted horizon values, with the training involving penalizing linear redundancies between pairs of bases selected from the lookback and horizon bases.

### CROSS-REFERENCE TO RELATED APPLICATIONS

The present disclosure claims priority to and benefit of U.S. provisional patent application No. 63/627,577, an entitled “METHOD AND SYSTEM FOR TRAINING AN IMPLICIT NEURAL REPRESENTATION NETWORK TO PERFORM TIME SERIES DATA FORECASTING”, the entirety of which is hereby incorporated by reference herein.

### TECHNICAL FIELD

The present disclosure is directed at methods, systems, and techniques for training an implicit neural representation network to perform time series data forecasting.

### BACKGROUND

Time-series forecasting is a challenging technical problem to address with machine learning. Time-series forecasting has shifted significantly in recent years from purely using statistical models with theoretical guarantees to incorporating more deep learning based models, enhancing the expressively in capturing more complex relationships in data. As an example, [1] proposes a hybrid of recurrent LSTM neural networks and the statistical Holt-Winters exponential smoothing model. Inspired by it, [2] proposes N-BEATS, a pure deep learning model to learn trend and seasonality from subsequent residual series, leading to a significant performance improvement over the hybrid model. More recently, pure deep learning models have dominated the field, especially for long horizon forecasting. N-HiTS as described in [3] introduces hierarchical interpolation and multi-rate sampling for learning time-series in respective frequency bands. Informer [4], Autoformer [5], and FEDformer [6] models leverage the architectural strengths of transformers to effectively capture dependencies across time steps. PatchTST [7] segments time-series data into patches due to the potential lack of semantic meaning in individual time steps, and applies masked self-supervised learning to efficiently train the transformer encoder.

### SUMMARY

According to a first aspect, there is provided a method for training an implicit neural representation (INR) network to perform time series data forecasting, the method comprising: obtaining a lookback time series of data and a horizon time series of data, wherein the lookback time series of data spans a lookback time window and the horizon time series of data spans a horizon time window following the lookback time window, wherein each of the series of data comprises time and corresponding sample values; determining a lookback basis and a horizon basis by processing the lookback time series of data using the INR network; determining weight and bias parameters using a regression based on the lookback basis and the lookback time series; forecasting predicted horizon values from the horizon basis values and the weight and bias parameters; and training the INR network to reduce forecast error between the horizon time series of data and the predicted horizon values, wherein the training comprises penalizing linear redundancies between pairs of bases selected from the lookback and horizon bases.

Penalizing may be performed by applying a covariance regularization.

Applying the covariance regularization may comprise adding a covariance regularization term to an objective function used to reduce the forecast error during the training of the INR network.

The objective function may comprise forecasting loss and the covariance regularization term.

The covariance regularization term may comprise a covariance matrix, and elements of the covariance matrix may represent covariances between the elements of the lookback and horizon bases.

The covariance matrix may be a centered covariance matrix.

The covariance matrix may be expressed as

$${G}_{θ} ( i j ) = \frac{1}{L + H} {\sum }_{τ ∈ \{ 0 , \frac{1}{L + H} … 1 \}} ( {z}_{τ}^{i} - {μ}^{i} ) ( {z}_{τ}^{j} - {μ}^{j} ) ,$$

$$where {μ}^{i} = \frac{1}{L + H} {\sum }_{τ} {z}_{τ}^{i} ,$$

where L is a lookback length, H is a forecast horizon, τ is a time index, and z is a basis.

Off-diagonal elements of the covariance matrix may be regularized towards zero, and diagonal elements of the covariance matrix may be regularized towards one.

The covariance regularization term may be

$${ℒ}_{C o v} ( θ ) = \frac{1}{{D}^{2}} [ {\sum }_{1 \leq i \neq j \leq D} {{G}_{i j} ( θ )}^{2} + {\sum }_{1 \leq i \leq D} {( {G}_{i i} ( θ ) - 1 )}^{2} ] ,$$

where D is a basis dimension and θ is a network parameter.

The objective function may be arg min_{θ}∥Y_{H}− [symbol] (θ,W*(θ),b*(θ))∥₂²+λ₂ [symbol] _{Cov}(θ), where Y_{H} is ground-truth, [symbol] is predicted horizon values, W* is a weight parameter, b* is a bias parameter, and λ₂ is a covariance regularization coefficient.

λ₂ may equal 1.

The lookback and horizon time series of data may be non-stationary.

The lookback and horizon time series of data may be noisy.

The regression may be a ridge regression.

Variances between the pairs of bases may be regularized towards 1 while penalizing the linear redundancies.

Lookback series of data may be non-uniformly sampled in time to perform the time series data forecasting at a higher frequency.

The method may further comprise performing the time series data forecasting by processing time series data with the INR network to generate one or more forecasts.

According to another aspect, there is provided a system for training an implicit neural representation (INR) network to perform time series data forecasting, the system comprising: at least one database having stored therein a lookback time series of data and a horizon time series of data, wherein the lookback time series of data spans a lookback time window and the horizon time series of data spans a horizon time window later in time than the lookback time window; at least one processor communicatively coupled with the at least one database; and at least one memory communicatively coupled to the at least one processor, the at least one memory having stored thereon computer program code that is executable by the at least one processor and that, when executed by the at least one processor, causes the at least one processor to perform the above method.

According to another aspect, there is provided at least one non-transitory computer readable medium having stored thereon computer program code that is executable by at least one processor and that, when executed by the at least one processor, causes the at least one processor to perform the above method.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a flowchart of a method for training an implicit neural representation network to perform time series data forecasting, according to an example embodiment.

FIGS. 2A-2G depict graphs showing performances of an implicit neural representation network trained using the method of FIG. 1 in comparison to another method, according to example embodiments.

FIG. 3 depicts a computer system that may be used to implement the method for training an implicit neural representation network to perform time series data forecasting of FIG. 1, according to an example embodiment.

FIG. 4A depicts training of an implicit neural representation network using the method of FIG. 1 in comparison to another method, according to an example embodiment.

FIG. 4B depicts similarity matrices of an implicit neural representation network trained using the method of FIG. 1 and another method, according to an example embodiment.

FIG. 5 depicts graphs showing performances of an implicit neural representation network trained using the method of FIG. 1 on test-time interpolation, according to an example embodiment.

FIG. 6 depicts generation of forecasts using an implicit neural representation network trained using the method of FIG. 1 on test-time interpolation, according to an example embodiment.

FIG. 7 depicts a graph showing changes in a regularization term across training epochs for an implicit neural representation network trained using the method of FIG. 1 in comparison to an implicit neural representation network trained using another method, according to an example embodiment.

FIGS. 8A-8E depict forecasting plots generated using an implicit neural representation network trained using the method of FIG. 1 in comparison to other methods, according to example embodiments.

### DETAILED DESCRIPTION

Although deep learning has been a promising path for time-series forecasting, it suffers from ever changing distribution referred to as non-stationarity of time-series. Domain generalization [8], domain adaptation [9], and test time adaptation [10, 11] methods are common successful approaches to address non-stationarity in time-series. Adaptive RNN [12] tackles non-stationarity in time-series with two modules: one for characterizing distribution and another for reducing distribution mismatch over periods of time-series, enabling adaptive learning. RevIN [13] differs from Adaptive RNN by introducing a straightforward, model-agnostic two-stage method. It operates under the local stationarity assumption, normalizing input data with mean and standard deviation, and then denormalizes to restore the original statistics in the predicted time-series. Non-stationary transformers [14] stationarizes the time-series similar to RevIN, but introduces de-stationary module to recover the original attention on non-stationary series.

Deep time-index models have been developed for use in time-series forecasting. In comparison to the more common historical-value models, which typically produce forecasts at pre-defined moment(s) in the future based on a pre-defined sequence of recent values, time-index models utilize continuous functions of time. Time-index models have some appealing properties; for instance, the function(s) learned by the time-index models can have continuous dependence on time, which can be a useful inductive bias for representing typical time series data. Moreover, historical-value models often struggle with inconsistent input sequences or target horizons, while time-index models are well-suited for handling irregular sampling rates, missing values, and forecasts over a continuous horizon.

A method for performing time-series forecasting is known as “DeepTime”, as described in [15]. DeepTime is a deep time-index model that combines INRs (implicit neural representations) with meta-learning to dynamically adapt to distribution shift. It utilizes an INR network as a meta-learner to create a set of non-stationary time-series bases for both look-back and forecast-horizon series. These bases, when linearly combined with consistent weights, reconstruct the look-back series and predict the horizon series. This method inherently leverages the adaptive nature of meta-learning to fit linear weights during its inner step, allowing it to adapt to current distribution.

INR networks aim to represent discrete signals, e.g. an image, as continuous functions of its coordinates. They use neural networks to parameterize the mapping of coordinates to the signal values, e.g. image coordinates to pixel values. The key distinction between modern INR networks and MLPs lies in the adoption of periodic activation functions, as opposed to ReLU, or the incorporation of positional encodings. Meta-learning on INR networks can be interpreted as learning a prior function over the space of signals, resulting in faster convergence and better generalization. In time-series forecasting, DeepTime applies meta-learning on INRs to map time-steps as coordinates to a set of dictionary bases. These bases, once linearly combined, effectively reconstruct the time-series.

Meta-learning, also known as the “learning to learn” paradigm, trains on multiple tasks to generalize skills to new, unseen tasks, where each task is a learning problem itself. As an example, few-shot learning, addressed by meta-learning, aims to learn models which can rapidly learn a new class with only a handful of examples. The widely recognized MAML [16] algorithm divides each task into support and query sets, and learns a neural network initialization (meta-step) in a way that fine tuning on the support set with a few iterations (inner-step) yields effective performance on the query set. During inference, only the inner-step is performed to specialize the network for test query set. Reptile [17] simplifies MAML's approach by replacing its second-order derivative with a first-order estimation, enhancing computational efficiency. ANIL (Almost No Inner Loop) [18] examines the necessity of optimizing the entire neural network during inner-step. It discovers that optimizing solely the task-specific head in the inner-step can match MAML's performance. [19] employs a ridge/logistic regression as the classification head, effectively replacing the inner optimization step with ridge/logistic regression closed-form solution, thereby significantly enhancing efficiency.

Referring now to DeepTime, each forecast (e.g. each sample value in the horizon) is considered a distinct task. The support sets correspond to the recently observed data in the lookback window, and the query sets are the future values in the horizon window. In this framework, learning the INR basis is the outer loop, while ridge regression is the inner loop. Further, DeepTime employs a closed-form solution to the inner-loop optimization to improve efficiency.

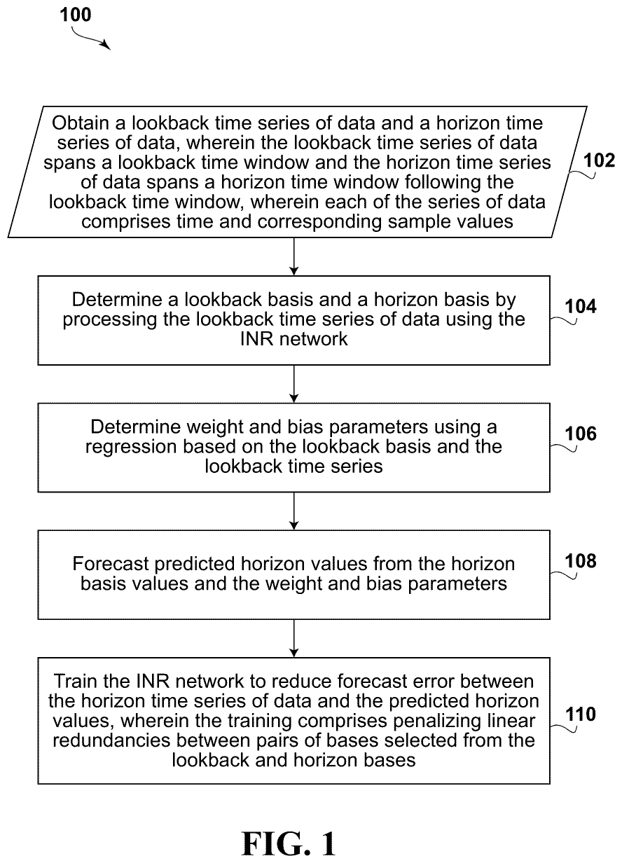

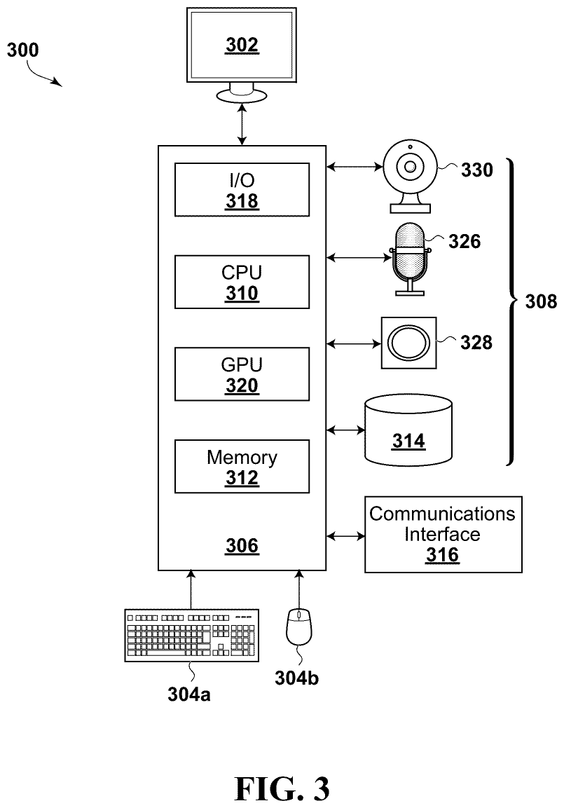

Generally speaking, the embodiments described herein are directed at methods, systems, and techniques for training an implicit neural representation network to perform time series data forecasting. An example method 100 (“covariance regularization method 100”) is depicted in the flowchart of FIG. 1. The method 100 may be encoded as computer program code that is executable by at least one processor and that, when executed by the at least one processor, causes the at least one processor to perform the method 100. An example processor that may be used to perform the method 100 is the CPU 310 and/or the GPU 320 described in further detail below in respect of FIG. 3.

The method 100 begins at block 102, where the at least one processor obtains a lookback time series of data and a horizon time series of data. The lookback time series of data spans a lookback time window and the horizon time series of data spans a horizon time window following the lookback time window. Each of the series of data can correspond to time series data comprising time and corresponding sample values (e.g. a time value and a data value corresponding to that time value). The method 100 proceeds to block 104, where the at least one processor determines a lookback basis and a horizon basis by processing the lookback time series of data using the INR network. The lookback series of data can be non-stationary, noisy, etc., as shown in the experiments. The method 100 then proceeds to block 106, where the at least one processor determines weight and bias parameters using a regression, such as a ridge regression, based on the lookback basis and the lookback time series. The at least one processor forecasts predicted horizon values from the horizon basis values and the weight and bias parameters at block 108, the INR network is then trained to reduce forecast error between the horizon time series of data and the predicted horizon values at block 108. During training at block 110, linear redundancies between pairs of bases selected from the lookback and horizon bases are penalized. Blocks 102, 104, 106, and 108 are returned to below when describing the method 100.

In particular, during training at block 110, the INR network can be conditioned using an additional regularization term. The regularization term can be used in combination with the forecasting error (e.g. loss as mean squared error) for training the INR network. Further, regularization of the covariance matrix through the use of the regularization term can better condition the regression. This can be achieved by penalizing off-diagonal elements in the covariance matrix to penalize linear redundancies between pairs of bases selected from the lookback and horizon bases, encouraging feature decorrelation. The regularization term can be implemented as a loss function (e.g. as an addition to the forecasting error). The modified overall loss would serve as the primary objective for the outer loop in the training of the INR network.

Broadly, the meta-learning objective for the INR network is: globally, learn a basis of normalized and uncorrelated time-indexed features such that, locally, forecasting can be done robustly by regression (e.g. ridge regression). Under certain assumptions, linear regression performs better when the explanatory variables are more uniformly normalized and less mutually correlated. Implementing regularization at block 110 can be simple, efficient, and can encourage these properties in the learned INR basis. In particular, the present disclosure can improve the forecasting accuracy of INR networks such as DeepTime models via regularization at block 110 while being computationally inexpensive. Further, the disclosed regularization technique at block 110 can facilitate the learning of more unit normalized and less mutually correlated basis representations to improve network performance on various benchmarks at little cost, including more challenging settings such as forecasting with missing values, training on smaller datasets, and forecasting at a higher-frequency at test-time compared to the training data.

Although the method 100, in particular regularization at block 110 is described with further detail herein in respect of the DeepTime model, it should be noted that the method 100 is analogously compatible with INR networks more generally. For example, regularization at block 110 can be applied for training INR network to perform forecasting using time series data and is not limited to DeepTime model(s), which are provided herein as an example. More specifically, regularization at block 110 can be applied in the training of INR networks relying on covariance matrices in regression.

Time series data can refer to a series of data points, each having one or more values associated with a time value or index. For example, a set of time series data can be a series or sequence of temperature values over a period of time, a series or sequence of monetary values over a period of time, etc. The forecasting task performed by the INR network may be the prediction of a subsequent value at a subsequent time (e.g. beyond the known data range) or a value at a particular time. For example, the INR network may to trained to perform weather forecasting by predicting temperature (e.g. in the future) or to perform stock price forecasting.

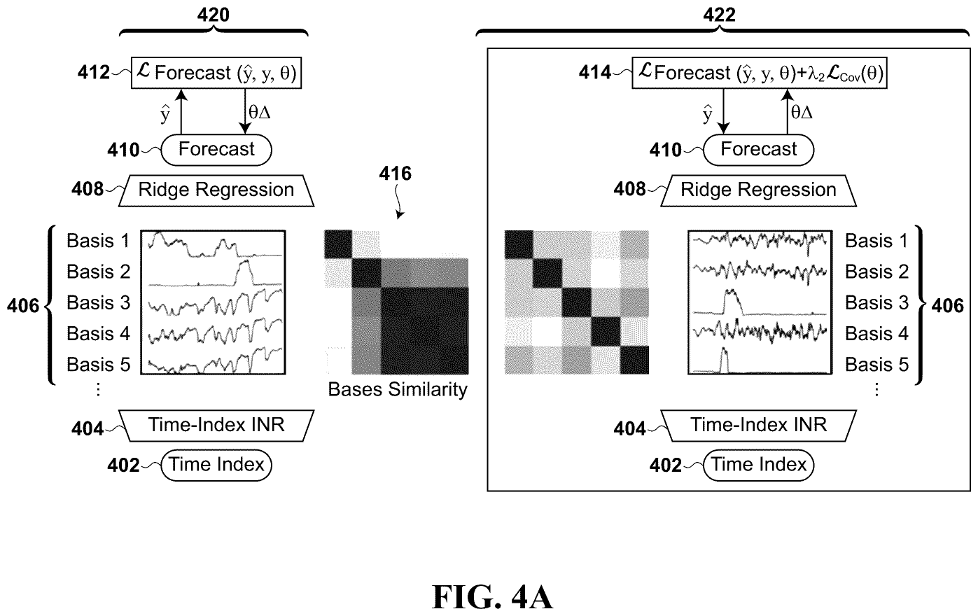

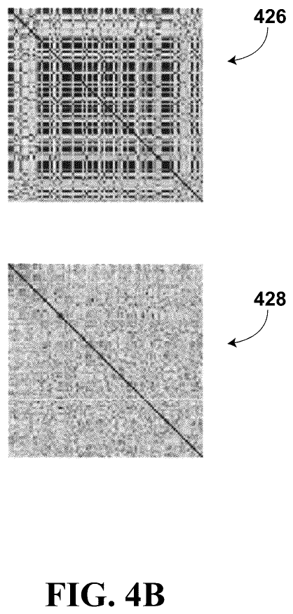

FIG. 4A depicts a representation of method 100 for use in training INR networks. In FIG. 4A, 420 depicts the standard framework for a DeepTime model and 422 depicts the same framework modified using regularization at block 110. As shown in FIG. 4A, the time series data 402 (e.g. time indices) is processed by the time-indexed INR network, in this case a DeepTime model. The plurality of basis functions 406 are determined or mapped by the INR network and processed using regression, in this case ridge regression 408 to determine the weights and biases thereof. The basis functions 406 and the corresponding weights and biases are used to perform forecasting 410. During training, the INR network learns the basis functions using the lookback series of data and performs forecasting 410 using the horizon basis values and the learned basis functions. In 420, the loss 412 for training the INR network is the forecasting loss, for example between the generated forecasts and the horizon series of data used as ground-truth. In contrast, the loss 414 used for training the INR network in 422 is formulated as a combination of the forecasting loss and the regularization term (represented as a regularization loss). Without the regularization term, the basis functions in 420 may exhibit more correlation to one another, as shown in bases similarity graph 416. In contrast, the additional regularization term added to the forecasting loss can promote more standardized and less correlated time-indexed basis elements (e.g. basis functions). This regularization can lead to more distinct basis elements, as shown in bases similarity graph 418, resulting in better conditioning for ridge regression and more robust forecasting.

FIG. 4B depicts cosine similarity matrices for basis elements of a standard DeepTime model (426) and a DeepTime model trained using the additional regularization term (428). As shown in FIG. 4B, the basis functions learned by INR network when trained using the additional regularization term are much closer to orthonormal.

### DeepTime Framework

DeepTime can aim to parameterize a time-indexed basis of features f(Δt) using an INR network. However, simply fitting a generic neural network to past values of y during inference can be slow and may lead to poor extrapolation into the future (e.g. a horizon time window). DeepTime can overcome this issue by framing forecasting as a meta-learning problem: globally, learn a basis of time-indexed features f(Δt) such that, locally, forecasting can be done by simple ridge regression. The INR training objective is the forecasting error, with the goal of finding a basis that can simultaneously: (a) fit the sample values of the lookback time window in a reliable manner and (b) extrapolate that fit to the forecast period (e.g. horizon time window) accurately. This formulation can achieve results competitive with other deep forecasting models on various benchmarks.

The DeepTime is described below, first in respect of inference and then training.

Consider an Implicit Neural Representation network (INR) f_{θ}:τ [symbol] zᵣ where τϵ[0,1] is called the time-index and z_{τϵ} [symbol] ^{D} represents the values of the D-dimensional basis at time τ. The time index τ is divided between the lookback and forecast regions: for example, given a lookback length L and forecast horizon H,

$$0 \leq τ \leq \frac{L}{L + H}$$

indexes into the lookback window while

$$\frac{L}{L + H} < τ \leq 1$$

indexes into the forecast period. Specifically,

$$τ = \frac{L}{L + H}$$

is the moment at which a forecast is to be made. Using the conventions defined in [15],

$$0 \leq τ \leq \frac{L - 1}{L + H - 1}$$

indexes into the lookback window while

$$\frac{L}{L + H - 1} < τ \leq 1$$

indexes into the forecast period where

$$τ = \frac{L}{L + H - 1}$$

is the moment at which a forecast is to be made.

Observed values of the target variable y in the lookback window are denoted by Y_{L}={y_{τ}_{₁},y_{τ}_{₂}, . . . y_{τ}_{_{N}}}, with τᵢ<τⱼ when i<j, τ₁≥0, and

$${τ}_{N} \leq \frac{L}{L + H} .$$

For regularly sampled data,

$${τ}_{1} = 0 , {τ}_{2} = \frac{1}{L + H} ,$$

and so on to

$${τ}_{N} = {τ}_{L} = \frac{L}{L + H} .$$

The model's forecast is referred to by ŷ(τ) for

$$\frac{L}{L + H} < τ \leq 1 .$$

Generally, a discrete set of forecasts Ŷ_{H}=(ŷ_{τ}_{_{N+1}},ŷ_{τ}_{_{N+2}}, . . . ŷ_{τ}_{_{N+M}}} is considered. For regularly sampled data, this can be specialized to

$${τ}_{N + 1} = \frac{L + 1}{L + H} , {τ}_{N + 2} = \frac{L + 2}{L + H} ,$$

and so on to τ_{N+M}=τ_{L+H}=1. Under the conventions of [15], values of the target variable y in the lookback window are denoted by Y_{L}={y_{τ}_{₁},y_{τ}_{₂}, . . . y_{τ}_{_{L}}}, with τᵢ<τⱼ when i<j, τ₁≥0, and

$${τ}_{L} \leq \frac{L - 1}{L + H - 1} .$$

For regularly sampled data,

$${τ}_{1} = 0 , {τ}_{2} = \frac{1}{L + H - 1} ,$$

and so on to

$${τ}_{L} = \frac{L - 1}{L + H - 1} .$$

The model's forecast would be referred to by ŷ(τ) for

$$\frac{L}{L + H - 1} < τ \leq 1 .$$

The discrete set of forecasts Ŷ_{H}={ŷ_{τ}_{_{L+1}},ŷ_{τ}_{_{L+2}}, . . . ŷ_{τ}_{_{L+H}}} is considered. For regularly sampled data, this can be specialized to

$${τ}_{L + 1} = \frac{L}{L + H - 1} , {τ}_{L + 2} = \frac{L + 1}{L + H - 1} ,$$

### and so on to τ_{L+H}=1.

In respect of inference, inference begins by evaluating the INR basis at the time index values for which lookback data are available: Z_{L}={zᵣ_{₁}, z_{τ}_{₂}, . . . z_{τ}_{_{N}}}={f_{θ}(τ₁),f_{θ}(τ₂), . . . , f_{θ}(τ_{N})}(where τ_{N} is interchangeable with τ_{L}). The past can be “explained” by solving the following system of equations for W and b: Y_{L}=Z_{L}W+b. Specifically, the ridge-regression optimal parameters are solved for:

$${{W}^{*} , {b}^{*} = arg {min}_{W , b} {‖ {Y}_{L} - {Z}_{L} W - b ‖}_{2}^{2} + λ ( ‖ W {\vert \vert}_{2}^{2} + ‖ b ‖}_{2}^{2} ) \qquad ( 1 )$$

where λ is the L2 penalty coefficient. This has the closed-form solution W*=(Z^{T}Z+λI)⁻¹Z^{T}Y_{L}. Alternatively, (W*, b*)=( [symbol] \tilde{Z}_{L}+λ₁I)⁻¹ [symbol] Y_{L}, where \tilde{Z}_{L}=[Z_{L}; 1]. The parameters Ŵ=(W*, b*) that solve the ridge regression problem minimize the prediction errors over the lookback window are used to extrapolate ŷ(τ)=z_{τ}W*+b* into the forecast region and generate the set of predictions:

$$= {Z}_{H} {W}^{*} + {b}^{*} \qquad ( 2 )$$

where, Z_{H}={z_{τ}_{_{N+1}}, z_{τ}_{_{N+2}}, . . . z_{τ}_{_{N+M}}}, or Z_{H}={z_{τ}_{_{L+1}}, z_{τ}_{_{L+2}}, . . . z_{τ}_{_{L+H}}} under [15]. The core idea is that knowing how the base learner as a ridge regression solves for the optimal parameter, the meta-learner f_{θ} learns the basis that allows the base learner to “forecast the future”. The time series of data corresponding to the lookback length L (i.e., Y_{L} and its corresponding time values) and the forecast horizon H (i.e., Y_{H} and its corresponding time values) are the lookback time series of data and the horizon time series of data referred to in block 102, respectively. Analogously, Z_{L} and Z_{H} respectively correspond to the lookback basis and horizon basis referred to in block 104, respectively. In particular, there is one pair of lookback-horizon windows for each time inference if performed, while training (discussed in respect of block 110 above and again below) is performed iteratively over many such pairs.

For the experiments in respect of the conditioning network described below, a modified INR backbone is used that depends directly on an embedding of all the lookback window data. This detail is omitted from notation for simplicity, but note that f_{θ}(θ) may actually be of the more general form f_{θ}(τ; Y_{L}). Such a model may be a hybrid of a time-index and historical-value model (e.g., if the conditioning network is a historical-value model).

During training, the meta-learner f_{θ} is exposed to the way in which the base learner (i.e., ridge regression in this example) solves for the optimal parameters (W*, b*), and can therefore learn an INR basis that allows the base learner to forecast the future reliably.

DeepTime optimizes the INR f_{θ} to learn basis {zₜ} that enables the above inference procedure to obtain optimal (i.e., minimal) forecast errors. Specifically, given Y_{L}, Z_{L} and Z_{H}, first optimal Ŵ=(W*, b*) is found and Y_{H} is determined as described above. W* and b*represent the weight and bias parameters referred to in block 106 of FIG. 1. Subsequently, θ is optimized, which parameterizes f_{θ} to minimize the forecast error, which is the mean square error below:

$$arg {min}_{θ} {‖ {Y}_{H} - ( θ , {W}^{*} ( θ ) , {b}^{*} ( θ ) ) ‖}_{2}^{2} \qquad ( 3 )$$

where Y_{H} represents the ground-truth observations at the same time indices as [symbol] , which represents the predicted horizon values that are forecast and referenced in block 108 of FIG. 1. Note that the inner optimization step depends on θ, as implied by the notation W*(θ), b*(θ)). The closed form solution to ridge regression enables DeepTime to propagate efficient, high-quality gradients through the entire inner optimization step. The meta-learning step is used for DeepTime's adaptation for time series forecasting: among all possible representations, the INR seeks to learn the ones that allow the ridge regression solver to explain the past values Y_{L} in such a way as to reliably forecast the future values Y_{H}.

### Regularized Basis

The following describes introduction of the covariance regularization method 100 on the regressors in the ridge linear meta-learner, applicable to a correlated noise sequence. Regularization, as described herein, can correspond to block 110 in method 100. In contrast to DeepTime, among all INR representations that allow the ridge regression solver Ŵ=(W*, b*) to explain the past X_{L} so as to forecast the future X_{H}, the covariance regularization method 100 searches for the most uncorrelated factors. This is because uncorrelated features lead to more robust ridge regression, which may lead to improved finite sample efficiency of least squares in certain embodiments. These factors may also be normalized to roughly the same scale to promote robust ridge regression.

The regularization technique described herein can improve the forecasting accuracy of the INR network by refining the basis functions learned by the INR. Informally, regularization at block 110 aims to learn temporal patterns in the basis elements that will improve the forecasting accuracy. Since “good” temporal patterns are highly dependent on the specific forecasting task, it can be difficult to define them in a domain-agnostic way. Therefore, this problem may be addressed in view of the ridge regression employed by the INR network (e.g. DeepTime as described herein). Instead of learning basis elements that are better suited for ridge regression, key properties of such a basis can be identified. The objective of the disclosed regularization can be to encourage these properties during the training of the INR network in method 100.

With regard to conditioning of linear regression on correlated variates, traditional methods assume that the correlated variates are specified externally to the problem, and then seek to process them one way or another to minimize the impact of the collinearity on the regression process. In contrast, the INR representation (e.g. in DeepTime) can be entirely learned with no externally specified collinear variates to disentangle. The present disclosure can exploit the unique freedom in this setting to construct these variates specifically such that they lead to a well-conditioned regression problem.

Linear regression problems have been the subject of numerous theoretical analyses owing to their simplicity and efficiency. Theoretical results from [20] can be used to develop an understanding of how the basis influences the prediction errors. One theorem in [20] suggests that the smallest and the largest eigenvalues (λₘᵢₙ and λₘₐₓ) of the sample covariance matrix influence the sample-efficiency for a required error threshold. Therefore, for a given number of train samples, a basis whose covariance matrix has larger λₘᵢₙ and smaller λₘₐₓ would result in lower prediction error. As such, it is possible to improve the ridge regression optimization by controlling the eigenvalues of the covariance matrix through a regularization term at block 110.

Conventionally, linear regression is applied directly to observed data with a fixed data-determined covariance matrix. In contrast, the basis zₜ in the present disclosure can be learned, enabling direct control of the covariance matrix properties. While it is possible in principle to directly minimize the largest eigenvalue and maximize the smallest eigenvalue of the sample covariance matrix, it can be practical to make two variations. In particular, it may be more practical to (1) regularize the centred covariance matrix and (2) to indirectly regularize the eigenvalues in the covariance matrix.

When applying least squares to real-world data, the data collection procedure typically cannot be controlled, let alone the data's covariance matrix. In particular, highly correlated regressors leads to ill-conditioned data matrices, which can lead to both numerical instabilities and statistical inefficiency. In the case of DeepTime, however, it is possible to specify the desired covariance properties of the regressors, which are activations of the INR f_{θ}. In other words, in contrast to taking the input features as they are, it is possible to choose regressors to ease least squares' learning in the time series setting.

To encourage the INR network to learn a basis with a better-conditioned covariance matrix, instead of regularizing the uncentered covariance matrix, the centered covariance matrix can be regularized at block 110. The centered covariance matrix can be in the form

$${G}_{θ} = \frac{1}{L + H} {Z}^{T} Z - {μ}_{Z} {μ}_{Z}^{T} ,$$

where G_{θ}(ij) indicates the covariance between the i-th and j-th basis elements, Z=[Z_{L}; Z_{H}] is the concatenation of the lookback and forecast bases and

$$μ = \frac{1}{L + H} {\sum }_{τ} {z}_{τ} ∈ {ℝ}^{D}$$

is the mean along the temporal axis for each of the D basis dimensions. Compared to regularizing the uncentered covariance matrix, this approach leaves the absolute means of the basis elements unconstrained, which can provide flexibility that is advantageous during training of the INR network.

Based on the Weyl inequalities from [21], controlling the eigenvalues of the centered covariance matrix can also control most of the eigenvalues of the uncentered covariance matrix. The exception is the largest eigenvalue, which can be poorly controlled if the basis elements are large.

For Hermitian matrices A, Bϵ [symbol] ⁿ, the eigenvalues of A+B are related to the eigenvalues of the individual matrices as follows: λᵢ₊ⱼ₋₁(A+B)≤λλᵢ(A)+λⱼ(B), i+j≤n+1; and λᵢ(A)+λⱼ(B)≤λᵢ₊ⱼ₋ₙ(A+B),i+j≥n+1 where i, j=1, . . . , n and cₙ≤λₙ₋₁≤ . . . ≤λ₁.

Specifically, if A=G_{θ}, B=μμ^{T}, and

$$A + B = \frac{1}{L + H} Z {Z}^{T} ,$$

it is possible to find upper- and lower-bounds for the eigenvalues of the uncentered covariance matrix. Note that (μμ^{T})μ=μ(μ^{T}μ)=(μ^{T}μ)μ, and since μμ^{T} is rank one, the only non-zero eigenvalue of μμ^{T} is μ^{T}μ>0.

Considering i=n and j=n in λᵢ(A)+λⱼ(B)≤λᵢ₊ⱼ₋ₙ(A+B), i+j≥n+1, then

$${λ}_{n} ( {G}_{θ} ) \leq {λ}_{n} ( \frac{1}{L + H} Z {Z}^{T} ) .$$

That is, the smallest eigenvalue of the uncentered covariance matrix (which should not be too small, according to [20]) is lower-bounded by the smallest eigenvalue of the centered covariance G_{θ}. Thus, it can be sufficient to control the smallest eigenvalue via G_{θ}. Considering j=1 and i=1 in λᵢ₊ⱼ₋₁(A+B)≤λᵢ(A)+λⱼ(B), i+j≤n+1, then

$${λ}_{1} ( \frac{1}{L + H} Z {Z}^{T} ) \leq {λ}_{1} ( {G}_{θ} ) + {μ}^{T} μ .$$

That is, the largest eigenvalue of the uncentered covariance matrix can exceed that of G_{θ} by μ^{T}μ for basis means μ.

It should be noted that INR network generally does not learn basis elements with pathologically large means. The INR initialization and training protocols may not find it conducive to representing such functions a priori, and a forecast error term may be sufficient to prevent them from emerging during training. Conversely, experiments were conducted to empirically show that the extra flexibility of unconstrained basis means can be advantageous to the training process. Thus, regularizing Go instead of the uncentered covariance matrix can be the more practical approach.

In particular, directly regularizing the largest and smallest eigenvalues of Go can lead to instabilities in the optimization process. Instead, it can be more tractable and effective to regularize G_{θ} towards the identity matrix, thereby regularizing all of its eigenvalues towards 1 at block 110.

Concretely, a covariance regularization is introduced to penalize linear redundancies between zⁱ and z^{j}, where 1≤i≠j≤D. Linear redundancies between the basis elements as the parameters W*, b* are identified by solving a linear-system of equations as described in Eq. 1: in other words, the solver can only exploit linear dependencies between the basis elements. If the basis matrix Z is defined by concatenating the lookback basis and forecast basis as Z=[Z_{L}; Z_{H}], the sample covariance matrix G_{θ} can be determined as:

$${G}_{θ} ( i j ) = \frac{1}{L + H} {\sum }_{τ ∈ \{ 0 , \frac{1}{L + H} … 1 \}} ( {z}_{τ}^{i} - {μ}^{i} ) ( {z}_{τ}^{j} - {μ}^{j} ) where , {μ}^{i} = \frac{1}{L + H} {\sum }_{τ} {z}_{τ}^{i} .$$

The covariance regularization term is defined by regularizing the off-diagonal elements to be close to 0 and encouraging the diagonal elements to be close to 1:

$${ℒ}_{C o v} ( θ ) = \frac{1}{{D}^{2}} [ {\sum }_{1 \leq i \neq j \leq D} {{G}_{i j} ( θ )}^{2} + {\sum }_{1 \leq i \leq D} {( {G}_{i i} ( θ ) - 1 )}^{2} ] \qquad ( 4 )$$

Intuitively, the first sum in [symbol] _{Cov}(θ) penalizes non-zero covariances between elements in the centered basis, while the second sum encourages the variances of each element in the centered basis to be close to 1. Therefore, when [symbol] _{Cov}(θ) is small, the centered basis is closer to orthonormal, and it is orthonormal if and only if G_{θ} equals the identity matrix. The fact that all the eigenvalue of G_{θ} lie within an interval near 1, with the size of the interval upper-bounded in proportion to [symbol] _{Cov}(θ), directly follows from [22].

In particular, Let A be a complex n×n matrix with entries aᵢⱼ. For iϵ{1, . . . , n} let Rᵢ be the sum of the absolute values of the non-diagonal entries in the i-th row: Rᵢ=Σ_{j≠i}|aᵢⱼ|. Let D(aᵢᵢ, Rᵢ)⊂C be a closed disc centered at aᵢᵢ with radius Rᵢ. Such a disc is called a Gershgorin disc. Then every eigenvalue of A lie within at least one of the Gershgorin discs D(aᵢᵢ, Rᵢ).

More specifically, in the context of regularizing G_{θ} using [symbol] _{Cov}(θ), note first that the radii of the Gershgorin discs of G_{θ} are constrained to be small when [symbol] _{Cov}(θ) is small because Rᵢ²[G_{θ}]=(Θ_{1≤i≠≤D}|G_{θ(ij)|)}²≤(D−1)Σ_{1≤i≠j≤D}G_{θ}(ij)²≤(D−1)D² [symbol] _{Cov}(θ). Moreover, the center of each i-th disc is close to 1 according to (G_{θ}(ii)−1)²≤D² [symbol] _{Cov}(θ). For sufficiently small [symbol] _{Cov}(θ) (for any fixed choice of D), all eigenvalues therefore lie within Gershgorin discs having small radii and centers close to 1. Since G_{θ} is Hermitian, its eigenvalues are real, and for small [symbol] _{Cov}(θ), the eigenvalues must therefore lie in small intervals near 1. In particular, the smallest eigenvalue is lower bounded by λₙ(G_{θ})≥1−(\sqrt{(D−1)D² [symbol] _{Cov}(θ)}+\sqrt{D² [symbol] _{Cov}(θ)})=1−(\sqrt{D−1}+1)D\sqrt{ [symbol]_{Cov}(θ)}, so when \sqrt{ [symbol]_{Cov}(θ)}<1/(\sqrt{D−1}+1)D, λₙ(G_{θ})>0 and the basis is non-degenerate. Similarly, the largest eigenvalue of G_{θ} also cannot be very large when [symbol] _{Cov}(θ) is small.

Although the theory by [20] does not directly require all eigenvalues to be near 1 for regression to be robust, this can be a sufficient condition for their robustness results to apply. Specifically, this theory's regression error bounds diverge as the smallest eigenvalue of the uncentered covariance matrix approaches zero, which is an outcome that [symbol] _{Cov}(θ) directly discourages.

The covariance regularization method 100 differs from the original formulation of DeepTime by changing the overall objective for the outer loop of training to the following:

$$arg {min}_{θ} {\vert \vert {Y}_{H} - ( θ , {W}^{*} ( θ ) , {b}^{*} ( θ ) ) \vert \vert}_{2}^{2} + {λ}_{2} {ℒ}_{C o v} ( θ ) , \qquad ( 5 )$$

where λ₂ is the covariance regularization coefficient. Note that constraining [symbol] _{Cov}(θ) can improve the conditioning of the INR basis. The smallest eigenvalue of the uncentered covariance matrix can be discouraged from being too small, with an upper bound of its distance below 1 controlled in proportion to [symbol] _{Cov}(θ). The largest eigenvalue of the centered covariance matrix can also be bounded near 1, with the largest eigenvalue of the uncentered covariance matrix growing only insofar as the basis means are large. Further, minimizing Equation (5) can reduce [symbol] _{Cov}(θ) substantially, which can grow with training epochs, suggesting that the basis is becoming increasingly ill-conditioned over time.

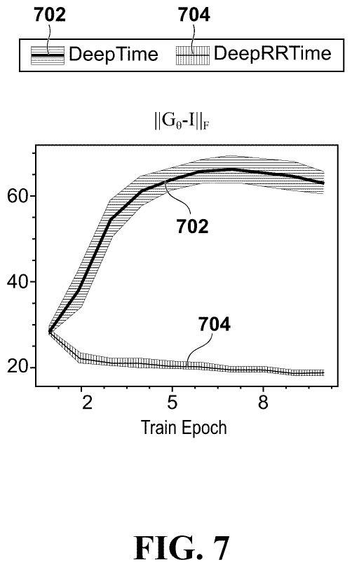

FIG. 7 depicts the reduction of [symbol] _{Cov}(θ) using the regularization term. In FIG. 7, [Σ_{1≤i≠j≤D}Gᵢⱼ(θ)²+Σ_{1≤i≤D}(Gᵢᵢ(θ)−1)²] is plotted across training epochs on the ETTm2 dataset with forecast horizon 96 and lookback multiplier μ=1. The shaded areas show standard deviations over 10 network initializations and trendlines of DeepTime and DeepTime modified using the regularization term are shown as 202 and 204, respectively. While [Σ_{1≤i≠j≤D}Gᵢⱼ(θ)²+Σ_{1≤i≤D}(Gᵢᵢ(θ)−1)²] for DeepTime grows with epochs, use of the disclosed regularization term can effectively decrease this value which results in a less mutually correlated basis, leading to various improvements as disclosed herein.

In addition to regularizing the off-diagonal elements to prevent matrix degeneracy due to strong correlations between basis elements, the diagonal elements are also regularized in order to prevent degeneracy due to vanishing variance of basis elements. It was found to be sufficient to set the coefficient of the new regularization term to λ₂=1. This covariance regularization method 100 controls the covariance matrix leads to improved finite sample efficiency and lower variance of the meta-learning ridge regression estimator, rigorously justified by works of [20]. The training performed using the objective function of Eq. (5) is an example of the training referred to in block 110 of FIG. 1, and penalizing linear redundancies is performed using the covariance regularization term of Eq. (4).

### Eigenvalues

Since the sample covariance matrix G_{θ}=Z^{T}Z−μ_{Z}μ_{Z}^{T}, the data matrix is therefore: Z^{T}Z=G_{θ}+μ_{Z}μ_{Z}^{T}. Then λₘᵢₙ(G_{θ})+λₘᵢₙ(μ_{Z}μ_{Z}^{T})≤λₘᵢₙ(Z^{T}Z)≤λₘₐₓ(Z^{T}Z)≤λₘₐₓ(G_{θ})+λₘₐₓ(μ_{Z}μ_{Z}) by the Lidskii/Weyl inequality. Given optimization of G_{θ} as above, the INR feature matrix Z^{T}Z's eigenvalues will be well controlled. In the ridge regression, the data matrix is regularized by a and thus the corresponding matrix of interests is (Z^{T}Z+αI) from:

$$\hat{W} = {( {Z}^{T} Z + α I )}^{- I} {Z}^{T} y \qquad ( 6 )$$

The same reasoning can be applied above to bound (Z^{T}Z+αI)'s eigenvalues, as it applies to another matrix sum. Alternatively the data matrix Z^{T}Z may be regularized to be I; this however may be too restrictive, since this encourages all basis to have zero mean. Experiments are consistent with this observation; controlling G_{θ} results in better performance.

Additionally, recall a linear model with additive noise:

$$y = Z {W}_{0} + ϵ \qquad ( 7 )$$

where y∈ [symbol] ^{T×1} is the target, Z∈ [symbol] ^{N×p} is the INR feature matrix with bounded random elements, W₀∈ [symbol] ^{p} is the population ground truth parameter, the noise vector e∈ [symbol] ^{T×1} is a sub-Gaussian martingale difference sequence, and t indexes the number of samples used in the model. This is to address the practical cases where the noise is correlated. Rigorously, the following are the assumptions:
A1: There exists U>0 such that: P(|Z|≤U)=1;
A2: ∀N>0 there exists non-degenerate matrix M∈ [symbol] ^{p×p} such that

$$M = \frac{1}{N} E ( {Z}^{T} Z ) .$$

We denote λₘₐₓ≐ₘₐₓ(M) and λₘᵢₙ=λₘᵢₙ(M)>0 as M's maximal and minimal eigenvalues;
A3: [symbol] (∈ₙ| [symbol] ₙ₋₁)=0. Where [symbol] ₙ₋₁ is a filtration, ∈ₙ are independent of Z; and A4: The martingale difference sequence is R sub-Gaussian, i.e.

$$𝔼 ( {e}^{s {ϵ}_{n}} \vert {ℱ}_{n - 1} ) \leq {e}^{\frac{{s}^{2} {R}^{2}}{2}} .$$

The linear least squares cost function is defined as:

$${J}^{T} ( W , y ) = {( y - Z W )}^{T} ( y - ZW ) .$$

Given T samples the least squares solution is given b

$${\hat{W}}^{T} = {( {Z}^{T} Z )}^{- 1} {Z}^{T} y = {( \frac{1}{T} {\sum }_{n = 1}^{T} {z}_{n} {z}_{n}^{T} )}^{- 1} \frac{1}{T} {\sum }_{n = 1}^{T} {z}_{n}^{T} {y}_{t}$$

where zₙ^{T},n=1 . . . N are the rows of Z and xₙ, for all n=1 . . . N are the data samples. Ŵ^{T} is the value that minimizes the cost function J^{T}. If the expected value of the noise is 0 then the estimator is unbiased, i.e. the expected value of the estimator is the true parameter. By studying:

$$P ( {‖ {\hat{W}}^{T} - {W}_{0} ‖}_{∞} > r ) < ε$$

It would be beneficial to understand the properties of Z^{T}Z that make least squares learning more efficient.

The significance of controlling Z^{T}Z's eigenvalues comes from the following theorem for the martingale difference noise sequence version:

Under assumptions A1-A4 and let ε>0 and r>0 be given, then for all N>N(r, ε):

$$P ( {‖ {\hat{W}}^{T} - {W}_{0} ‖}_{∞} > r ) < ε where N ( r , ε ) = max \{ {N}_{1} ( r , ε ) , {N}_{rand} ( ε ) \} {N}_{1} ( r , ε ) = \frac{8 {a}^{2} {R}^{2}}{{r}^{2} {λ}_{min}^{2}} log \frac{2 p}{ε} and {N}_{rand} ( ε ) = \frac{4}{3} \frac{( 6 {λ}_{max} + {λ}_{min} ) ( p {a}^{2} + {λ}_{max} )}{{λ}_{min}^{2}} log \frac{2 p}{ε} .$$

The above theorem's sample complexity for a desired level of learning indexed by ε depends on (λₘᵢₙ, λₘₐₓ), the minimal and maximal eigenvalues of Z^{T}Z. Therefore, with a better conditioned data matrix, a high level of test performances for a fixed sample size can be achieved.

### Nonstationarity and Finite Sample Complexity

The covariance regularization method 100 may in at least some embodiments be particularly beneficial for practical locally stationary time series. On one hand, if the least squares estimator require a long time series as input, the less recent data may be distributed differently. This can ironically cause DeepTime's meta-learning step to fail to adapt, which is the core principle behind algorithms of the MAML type. On the other hand, if too short an input time series is provided, typical least squares may not be able to learn the parameters sufficiently well. Least squares' learning sample complexity can be improved by optimizing the eigenvalues of the regressors' covariance matrix.

### Experiments

Experiments are performed on 6 real-world datasets—Electricity Transformer Temperature (ETT), Electricity Consuming Load (ECL), Exchange, Traffic, Weather, and Influenza-like Illness (ILI). The performance of DeepTime trained with and without the regularization—distinguished as “DeepRRTime”—is evaluated using two metrics, the mean squared error (MSE) and mean absolute error (MAE) metrics. The datasets are split into train, validation, and test sets chronologically, following a 70/10/20 split for all datasets except for ETTm2 which follows a 60/20/20 split, as per convention. For each experiment, error statistics across 10 random network initializations are included. The univariate experiments select the last index of the multivariate dataset as the target variable. Preprocessing on the data is performed by standardization based on train set statistics. Hyperparameter selection, when applied, is performed on only one value, the lookback length multiplier, L=μ*H, which decides the length of the lookback window. The values μ=[1,3,5,7,9] are searched through, and select the best value based on the validation loss. Identical values for all common hyperparameters are used besides the lookback multiplier μ.

The following systematically analyzes the benefits of the covariance regularization method 100.

In this experiment, DeepTime models are trained and evaluated with and without covariance regularization. The optimal lookback multiplier reported in the original DeepTime paper [15] for the models trained without the regularization. For the models trained with regularization, the optimal lookback multiplier is selected based on the validation loss as suggested in [15]. Results are shown in Table 1. Overall, improvements are observed in 29 out of 48 evaluations. Quantitatively, a relative improvement of 1.66% and 2.72% is obtained on the MAE and MSE metrics respectively. In cases where applying the regularization led to drops in performance, the average decrease in performance is found to be 1.50% and 1.25% for the MAE and MSE metrics respectively. In contrast, the cases where the regularization obtained some improvement over the baseline, the average increase in performance is noted to be 5.06% and 9.45% respectively. In summary, these results demonstrate that the covariance regularization method 100 offers significant improvement over the baseline in cases where there is an improvement and in cases where there is a decrease in performance, that decrease is quantitatively much smaller as compared to improvements obtained with the covariance regularization method 100.

TABLE 1
Improvements over DeepTime. The results are averaged over 10 seeds except
for ECL where 3 seeds were used due to very long training time.

| | | DeepTime | | Covariance Regularization Method 100 | |
|---|---|---|---|---|---|
| Data | Forecast | MAE | MSE | MAE | MSE |
| ECL | 96 | 0.2384 ± 0.0003 | 0.1375 ± 0.0002 | 0.2374 ± 0.0003 | 0.1369 ± 0.0002 |
| | 192 | 0.2515 ± 0.0001 | 0.1521 ± 0.0001 | 0.2507 ± 0.0005 | 0.1517 ± 0.0003 |
| | 336 | 0.2679 ± 0.0001 | 0.1658 ± 0.0001 | 0.2671 ± 0.0004 | 0.1655 ± 0.0003 |
| | 720 | 0.3018 ± 0.0004 | 0.2012 ± 0.0002 | 0.3022 ± 0.0003 | 0.2016 ± 0.0002 |
| ETTm2 | 96 | 0.2581 ± 0.0019 10 | 0.1658 ± 0.0009 10 | 0.2585 ± 0.0021 10 | 0.1656 ± 0.0008 10 |
| | 192 | 0.2994 ± 0.0015 10 | 0.2227 ± 0.0019 10 | 0.3004 ± 0.0029 10 | 0.2241 ± 0.0022 10 |
| | 336 | 0.3386 ± 0.0039 10 | 0.2778 ± 0.0049 10 | 0.3378 ± 0.0030 10 | 0.2764 ± 0.0025 10 |
| | 720 | 0.4114 ± 0.0056 10 | 0.3830 ± 0.0062 10 | 0.3972 ± 0.0036 3 | 0.3685 ± 0.0027 3 |
| Exchange | 96 | 0.1995 ± 0.0018 | 0.0785 ± 0.0008 | 0.1950 ± 0.0009 | 0.0762 ± 0.0003 |
| | 192 | 0.2879 ± 0.0053 | 0.1529 ± 0.0037 | 0.2856 ± 0.0044 | 0.1549 ± 0.0029 |
| | 336 | 0.4385 ± 0.0406 | 0.3488 ± 0.0637 | 0.3777 ± 0.0022 | 0.2587 ± 0.0035 |
| | 720 | 0.6468 ± 0.0695 | 0.8019 ± 0.1682 | 0.5640 ± 0.0324 | 0.5886 ± 0.0735 |
| ILI | 24 | 1.1048 ± 0.0538 | 2.5058 ± 0.2104 | 1.0211 ± 0.0275 | 2.2611 ± 0.0715 |
| | 36 | 1.0573 ± 0.0448 | 2.3560 ± 0.1370 | 1.0325 ± 0.0378 | 2.3133 ± 0.1091 |
| | 48 | 1.0540 ± 0.0643 | 2.3430 ± 0.2572 | 1.0279 ± 0.0238 | 2.2704 ± 0.0944 |
| | 60 | 1.0271 ± 0.0299 | 2.2820 ± 0.1494 | 1.0326 ± 0.0499 | 2.2913 ± 0.1615 |
| Traffic | 96 | 0.2744 ± 0.0005 10 | 0.3902 ± 0.0003 10 | 0.2738 ± 0.0003 8 | 0.3900 ± 0.0004 8 |
| | 192 | 0.2784 ± 0.0005 10 | 0.4016 ± 0.0004 10 | 0.2784 ± 0.0006 4 | 0.4019 ± 0.0004 4 |
| | 336 | 0.2981 ± 0.0007 10 | 0.4433 ± 0.0008 10 | 0.2855 ± 0.0005 6 | 0.4163 ± 0.0006 6 |
| Weather | 96 | 0.2233 ± 0.0015 10 | 0.1667 ± 0.0012 10 | 0.2223 ± 0.0010 10 | 0.1661 ± 0.0006 10 |
| | 192 | 0.2603 ± 0.0014 10 | 0.2070 ± 0.0010 10 | 0.2603 ± 0.0007 10 | 0.2073 ± 0.0005 10 |
| | 336 | 0.3001 ± 0.0009 10 | 0.2522 ± 0.0010 10 | 0.2977 ± 0.0009 2 | 0.2501 ± 0.0006 2 |
| | 720 | 0.3504 ± 0.0011 6 | 0.3132 ± 0.0009 6 | 0.3474 ± 0.0008 4 | 0.3117 ± 0.0007 4 |

In the specific case of the Exchange dataset, an average improvement of 7.43% and 13.51% is observed in the MAE and MSE metrics respectively. The significance of these improvements should be considered noting that the Exchange dataset is the most nonstationary dataset—according to ADF metric [14]—amongst the considered datasets.

Regular multivariate time-series forecasting was performed using DeepTime trained using method 100 (referred to herein as the disclosed method and annotated as DeepRRTime), and compared with other time-index models. Comparison methods include DeepTime, to understand the relative benefits of the regularization, as well as historical-value models including recent Transformer-based architectures. Further, the performance of a simple martingale model that outputs the last observed value as a forecast is included, and was shown to be competitive on some Long-Term Sequence Forecasting (LTSF) benchmarks. All experiments are conducted with the regularization coefficient fixed to λ₂=1, as jointly optimizing λ₂ with the lookback multiplier p for the full set of benchmarks was prohibitively expensive. Table 2 shows comparison of the disclosed method with time-index models on multivariate benchmarks for long sequence time-series forecasting. For reference, the corresponding results for representative historical value models are included. Tables 3A and 3B show a comparison of the disclosed method with historical-value models on multivariate forecasting benchmarks for long sequence time-series forecasting. Best results are bolded, second best results are underlined, and best results overall are italicized in Tables 2-3B.

TABLE 2
Performance Comparison Between the Disclosed Method and Other Methods in Multivariate Benchmarks

| | | Time-index models | | | | | | | | Historical-value models | | | | | |
|---|---|---|---|---|---|---|---|---|---|---|---|---|---|---|---|
| | | DeepRRTime | | DeepTime | | GP | | TimeFlow | | NLinear | | Martingale | | PatchTST | |
| Metrics | | MSE | MAE | MSE | MAE | MSE | MAE | MSE | MAE | MSE | MAE | MSE | MAE | MSE | MAE |
| ETTm2 | 96 | 0.166 | 0.258 | 0.166 | 0.258 | 0.442 | 0.422 | 0.269 | 0.322 | 0.167 | 0.255 | 0.266 | 0.328 | 0.166 | 0.256 |
| | 192 | 0.224 | 0.300 | 0.223 | 0.299 | 0.605 | 0.505 | 0.394 | 0.399 | 0.221 | 0.293 | 0.340 | 0.371 | 0.223 | 0.296 |
| | 336 | 0.276 | 0.338 | 0.278 | 0.339 | 0.731 | 0.569 | 0.523 | 0.471 | 0.274 | 0.327 | 0.412 | 0.410 | 0.274 | 0.329 |
| | 720 | 0.368 | 0.397 | 0.383 | 0.411 | 0.959 | 0.669 | 0.663 | 0.557 | 0.368 | 0.384 | 0.521 | 0.465 | 0.362 | 0.385 |
| ECL | 96 | 0.137 | 0.238 | 0.137 | 0.238 | 0.503 | 0.538 | 0.141 | 0.240 | 0.141 | 0.237 | 1.588 | 0.946 | 0.129 | 0.222 |
| | 192 | 0.152 | 0.251 | 0.152 | 0.252 | 0.505 | 0.543 | 0.155 | 0.251 | 0.154 | 0.248 | 1.595 | 0.950 | 0.147 | 0.240 |
| | 336 | 0.165 | 0.267 | 0.166 | 0.268 | 0.612 | 0.614 | 0.170 | 0.268 | 0.171 | 0.265 | 1.617 | 0.961 | 0.163 | 0.259 |
| | 720 | 0.202 | 0.303 | 0.202 | 0.302 | 0.652 | 0.635 | 0.203 | 0.300 | 0.210 | 0.297 | 1.647 | 0.975 | 0.197 | 0.290 |
| Exchange | 96 | 0.078 | 0.197 | 0.079 | 0.199 | 0.136 | 0.267 | 0.307 | 0.395 | 0.089 | 0.208 | 0.081 | 0.196 | 0.088 | 0.207 |
| | 192 | 0.153 | 0.284 | 0.152 | 0.285 | 0.229 | 0.348 | 1.450 | 0.658 | 0.180 | 0.300 | 0.167 | 0.289 | 0.191 | 0.312 |
| | 336 | 0.257 | 0.375 | 0.324 | 0.424 | 0.372 | 0.447 | 3.691 | 1.063 | 0.331 | 0.415 | 0.305 | 0.396 | 0.358 | 0.436 |
| | 720 | 0.541 | 0.540 | 0.675 | 0.592 | 1.135 | 0.810 | 8.184 | 1.626 | 1.033 | 0.780 | 0.823 | 0.681 | 0.932 | 0.728 |
| Traffic | 96 | 0.390 | 0.274 | 0.390 | 0.274 | 1.112 | 0.665 | 2.623 | 0.287 | 0.410 | 0.279 | 2.723 | 1.079 | 0.360 | 0.249 |
| | 192 | 0.402 | 0.278 | 0.402 | 0.278 | 1.133 | 0.671 | 5.621 | 0.305 | 0.423 | 0.284 | 2.756 | 1.087 | 0.379 | 0.256 |
| | 336 | 0.416 | 0.285 | 0.416 | 0.289 | 1.274 | 0.723 | 23.648 | 0.331 | 0.435 | 0.290 | 2.791 | 1.095 | 0.392 | 0.264 |
| | 720 | 0.450 | 0.307 | 0.450 | 0.308 | 1.280 | 0.719 | 15.013 | 0.357 | 0.464 | 0.307 | 2.811 | 1.097 | 0.432 | 0.286 |
| Weather | 96 | 0.166 | 0.222 | 0.167 | 0.223 | 0.395 | 0.356 | 0.186 | 0.242 | 0.182 | 0.232 | 0.259 | 0.254 | 0.149 | 0.198 |
| | 192 | 0.207 | 0.260 | 0.207 | 0.260 | 0.450 | 0.398 | 0.252 | 0.299 | 0.225 | 0.269 | 0.309 | 0.292 | 0.194 | 0.241 |
| | 336 | 0.251 | 0.298 | 0.252 | 0.300 | 0.508 | 0.440 | 0.318 | 0.343 | 0.271 | 0.301 | 0.377 | 0.338 | 0.245 | 0.282 |
| | 720 | 0.312 | 0.348 | 0.313 | 0.350 | 0.498 | 0.450 | 0.393 | 0.394 | 0.338 | 0.348 | 0.465 | 0.394 | 0.314 | 0.334 |
| ILI | 24 | 2.317 | 1.044 | 2.558 | 1.115 | 2.331 | 1.036 | 3.199 | 1.228 | 1.683 | 0.858 | 6.587 | 1.701 | 1.319 | 0.754 |
| | 36 | 2.253 | 1.022 | 2.264 | 1.042 | 2.167 | 1.002 | 3.166 | 1.212 | 1.703 | 0.859 | 7.130 | 1.884 | 1.579 | 0.870 |
| | 48 | 2.292 | 1.033 | 2.302 | 1.027 | 2.961 | 1.180 | 3.128 | 1.180 | 1.719 | 0.884 | 6.575 | 1.798 | 1.553 | 0.815 |
| | 60 | 2.301 | 1.035 | 2.292 | 1.030 | 3.108 | 1.214 | 3.563 | 1.277 | 1.819 | 0.917 | 5.893 | 1.677 | 1.470 | 0.788 |

TABLE 3A
Performance Comparison Between the Disclosed Method and Historical-value Models in Multivariate Benchmarks

| | | Methods | | | | | | | | | | | | | | | | | |
|---|---|---|---|---|---|---|---|---|---|---|---|---|---|---|---|---|---|---|---|
| | | | | | | NS | | | | | | | | | | | | | |
| | | DeepRRTime | | PatchTST | | Transformer | | N-HiTS | | ETSformer | | FEDformer | | NLinear | | DLinear | | Martingale | |
| Metrics | | MSE | MAE | MSE | MAE | MSE | MAE | MSE | MAE | MSE | MAE | MSE | MAE | MSE | MAE | MSE | MAE | MSE | MAE |
| ETTm2 | 96 | 0.166 | 0.258 | 0.166 | 0.256 | 0.192 | 0.274 | 0.176 | 0.255 | 0.189 | 0.280 | 0.203 | 0.287 | 0.167 | 0.255 | 0.167 | 0.260 | 0.266 | 0.328 |
| | 192 | 0.224 | 0.300 | 0.223 | 0.296 | 0.280 | 0.339 | 0.245 | 0.305 | 0.253 | 0.319 | 0.269 | 0.328 | 0.221 | 0.293 | 0.224 | 0.303 | 0.340 | 0.371 |
| | 336 | 0.276 | 0.338 | 0.274 | 0.329 | 0.334 | 0.361 | 0.295 | 0.346 | 0.314 | 0.357 | 0.325 | 0.366 | 0.274 | 0.327 | 0.281 | 0.342 | 0.412 | 0.410 |
| | 720 | 0.368 | 0.397 | 0.362 | 0.385 | 0.417 | 0.413 | 0.401 | 0.426 | 0.414 | 0.413 | 0.421 | 0.415 | 0.368 | 0.384 | 0.397 | 0.421 | 0.521 | 0.465 |
| ECL | 96 | 0.137 | 0.238 | 0.129 | 0.222 | 0.169 | 0.273 | 0.147 | 0.249 | 0.187 | 0.304 | 0.183 | 0.297 | 0.141 | 0.237 | 0.140 | 0.237 | 1.588 | 0.946 |
| | 192 | 0.152 | 0.251 | 0.147 | 0.240 | 0.182 | 0.286 | 0.167 | 0.269 | 0.199 | 0.315 | 0.195 | 0.308 | 0.154 | 0.248 | 0.153 | 0.249 | 1.595 | 0.950 |
| | 336 | 0.165 | 0.267 | 0.163 | 0.259 | 0.200 | 0.304 | 0.186 | 0.290 | 0.212 | 0.329 | 0.212 | 0.313 | 0.171 | 0.265 | 0.169 | 0.267 | 1.617 | 0.961 |
| | 720 | 0.202 | 0.303 | 0.197 | 0.290 | 0.222 | 0.321 | 0.243 | 0.340 | 0.233 | 0.345 | 0.231 | 0.343 | 0.210 | 0.297 | 0.203 | 0.301 | 1.647 | 0.975 |
| Exchange | 96 | 0.078 | 0.197 | 0.088 | 0.207 | 0.111 | 0.237 | 0.092 | 0.211 | 0.085 | 0.204 | 0.139 | 0.276 | 0.089 | 0.208 | 0.081 | 0.203 | 0.081 | 0.196 |
| | 192 | 0.153 | 0.284 | 0.191 | 0.312 | 0.219 | 0.335 | 0.208 | 0.322 | 0.182 | 0.303 | 0.256 | 0.369 | 0.180 | 0.300 | 0.157 | 0.293 | 0.167 | 0.289 |
| | 336 | 0.257 | 0.375 | 0.358 | 0.436 | 0.421 | 0.476 | 0.371 | 0.443 | 0.348 | 0.428 | 0.426 | 0.464 | 0.331 | 0.415 | 0.305 | 0.414 | 0.305 | 0.396 |
| | 720 | 0.541 | 0.540 | 0.932 | 0.728 | 1.092 | 0.769 | 0.888 | 0.723 | 1.025 | 0.774 | 1.090 | 0.800 | 1.033 | 0.780 | 0.643 | 0.601 | 0.823 | 0.681 |
| Traffic | 96 | 0.390 | 0.274 | 0.360 | 0.249 | 0.612 | 0.338 | 0.402 | 0.282 | 0.607 | 0.392 | 0.562 | 0.349 | 0.410 | 0.279 | 0.410 | 0.282 | 2.723 | 1.079 |
| | 192 | 0.402 | 0.278 | 0.379 | 0.256 | 0.613 | 0.340 | 0.420 | 0.297 | 0.621 | 0.399 | 0.562 | 0.346 | 0.423 | 0.284 | 0.423 | 0.287 | 2.756 | 1.087 |
| | 336 | 0.416 | 0.285 | 0.392 | 0.264 | 0.618 | 0.328 | 0.448 | 0.313 | 0.622 | 0.396 | 0.570 | 0.323 | 0.435 | 0.290 | 0.436 | 0.296 | 2.791 | 1.095 |
| | 720 | 0.450 | 0.307 | 0.432 | 0.286 | 0.653 | 0.355 | 0.539 | 0.353 | 0.632 | 0.396 | 0.596 | 0.368 | 0.464 | 0.307 | 0.466 | 0.315 | 2.811 | 1.097 |
| Weather | 96 | 0.166 | 0.222 | 0.149 | 0.198 | 0.173 | 0.223 | 0.158 | 0.195 | 0.197 | 0.281 | 0.217 | 0.296 | 0.182 | 0.232 | 0.176 | 0.237 | 0.259 | 0.254 |
| | 192 | 0.207 | 0.260 | 0.194 | 0.241 | 0.245 | 0.285 | 0.211 | 0.247 | 0.237 | 0.312 | 0.276 | 0.336 | 0.225 | 0.269 | 0.220 | 0.282 | 0.309 | 0.292 |
| | 336 | 0.251 | 0.298 | 0.245 | 0.282 | 0.321 | 0.338 | 0.274 | 0.300 | 0.298 | 0.353 | 0.339 | 0.380 | 0.271 | 0.301 | 0.265 | 0.319 | 0.377 | 0.338 |
| | 720 | 0.312 | 0.348 | 0.314 | 0.334 | 0.414 | 0.410 | 0.351 | 0.353 | 0.352 | 0.388 | 0.403 | 0.428 | 0.338 | 0.348 | 0.323 | 0.362 | 0.465 | 0.394 |
| ILI | 24 | 2.317 | 1.044 | 1.319 | 0.754 | 2.294 | 0.945 | 1.862 | 0.869 | 2.527 | 1.020 | 2.203 | 0.963 | 1.683 | 0.858 | 2.215 | 1.081 | 6.587 | 1.701 |
| | 36 | 2.253 | 1.022 | 1.579 | 0.870 | 1.825 | 0.848 | 2.071 | 0.969 | 2.615 | 1.007 | 2.272 | 0.976 | 1.703 | 0.859 | 1.963 | 0.963 | 7.130 | 1.884 |
| | 48 | 2.292 | 1.033 | 1.553 | 0.815 | 2.010 | 0.900 | 2.346 | 1.042 | 2.359 | 0.972 | 2.209 | 0.981 | 1.719 | 0.884 | 2.130 | 1.024 | 6.575 | 1.798 |
| | 60 | 2.301 | 1.035 | 1.470 | 0.788 | 2.178 | 0.963 | 2.560 | 1.073 | 2.487 | 1.016 | 2.545 | 1.061 | 1.819 | 0.917 | 2.368 | 1.096 | 5.893 | 1.677 |

TABLE 3B
Performance Comparison Between the Disclosed Method and Historical-
value Models in Multivariate Benchmarks (continued)

| | | Methods | | | | | | | | | |
|---|---|---|---|---|---|---|---|---|---|---|---|
| | | DeepRRTime | | CrossFormer | | TimesNet | | iTransformer | | PatchTST | |
| Metrics | | MSE | MAE | MSE | MAE | MSE | MAE | MSE | MAE | MSE | MAE |
| ETTm2 | 96 | 0.166 | 0.258 | 0.287 | 0.366 | 0.187 | 0.267 | 0.18 | 0.264 | 0.166 | 0.256 |
| | 192 | 0.224 | 0.3 | 0.414 | 0.492 | 0.249 | 0.309 | 0.25 | 0.309 | 0.223 | 0.296 |
| | 336 | 0.276 | 0.338 | 0.597 | 0.542 | 0.321 | 0.351 | 0.311 | 0.348 | 0.274 | 0.329 |
| | 720 | 0.368 | 0.397 | 1.73 | 1.042 | 0.408 | 0.403 | 0.412 | 0.407 | 0.362 | 0.385 |
| ECL | 96 | 0.137 | 0.238 | 0.219 | 0.314 | 0.168 | 0.272 | 0.148 | 0.24 | 0.129 | 0.222 |
| | 192 | 0.152 | 0.251 | 0.231 | 0.322 | 0.184 | 0.289 | 0.162 | 0.253 | 0.147 | 0.240 |
| | 336 | 0.165 | 0.267 | 0.246 | 0.337 | 0.198 | 0.3 | 0.178 | 0.269 | 0.163 | 0.259 |
| | 720 | 0.202 | 0.303 | 0.28 | 0.363 | 0.22 | 0.32 | 0.225 | 0.317 | 0.197 | 0.290 |
| Exchange | 96 | 0.078 | 0.197 | 0.256 | 0.367 | 0.107 | 0.234 | 0.086 | 0.206 | 0.088 | 0.207 |
| | 192 | 0.153 | 0.284 | 0.47 | 0.509 | 0.226 | 0.344 | 0.177 | 0.299 | 0.191 | 0.312 |
| | 336 | 0.257 | 0.375 | 1.268 | 0.883 | 0.367 | 0.448 | 0.331 | 0.417 | 0.358 | 0.436 |
| | 720 | 0.541 | 0.54 | 1.767 | 1.068 | 0.964 | 0.746 | 0.847 | 0.691 | 0.932 | 0.728 |
| Traffic | 96 | 0.39 | 0.274 | 0.522 | 0.29 | 0.593 | 0.321 | 0.395 | 0.268 | 0.360 | 0.249 |
| | 192 | 0.402 | 0.278 | 0.53 | 0.293 | 0.617 | 0.336 | 0.417 | 0.276 | 0.379 | 0.256 |
| | 336 | 0.416 | 0.285 | 0.558 | 0.305 | 0.629 | 0.336 | 0.433 | 0.283 | 0.392 | 0.264 |
| | 720 | 0.45 | 0.307 | 0.589 | 0.328 | 0.64 | 0.35 | 0.467 | 0.302 | 0.432 | 0.286 |
| Weather | 96 | 0.166 | 0.222 | 0.158 | 0.23 | 0.172 | 0.22 | 0.174 | 0.214 | 0.149 | 0.198 |
| | 192 | 0.207 | 0.26 | 0.206 | 0.277 | 0.219 | 0.261 | 0.221 | 0.254 | 0.194 | 0.241 |
| | 336 | 0.251 | 0.298 | 0.272 | 0.335 | 0.28 | 0.306 | 0.278 | 0.296 | 0.245 | 0.282 |
| | 720 | 0.312 | 0.348 | 0.398 | 0.418 | 0.365 | 0.359 | 0.358 | 0.347 | 0.314 | 0.334 |

Based on the above results, the disclosed method matched or exceeded the performances of other time-index models overall and achieved the best performance out of the time-index models in 38 out of 48 settings in Table 2. Moreover, considering the standard deviations and the fourth digit of precision (see Table 4 below), the cases where DeepTime outperformed the disclosed method are generally not statistically significant: only the difference in MSE on ECL/720 came close, with a difference slightly exceeding two standard errors. Similarly, the underperformance relative to GP on ILI/24 is not statistically significant. Altogether, accounting for measurement uncertainty, the disclosed method matched or exceeded the other time-index models in 45 out of 48 results, and matched or exceeded DeepTime in all settings. Conversely, 17 of the cases where DeepRRTime outperformed DeepTime are statistically significant as determined by a one-sided Welch's t-test with a significance level of 0.05. Most notably, the covariance regularization introduced significant improvements on the Exchange dataset, especially on the longest forecast horizons (336, 720) where between 10% and 20% improvement in MAE and MSE over DeepTime are observed. Altogether, these results suggest that the use of the regularization term at block 110 is a clear improvement to DeepTime's already state-of-the-art performance among time-index models. For reference, Table 4 shows another comparison between the disclosed method and DeepTime on multivariate benchmarks for long sequence time series forecasting. Best results are highlighted in bold. The table includes mean and standard deviation over 10 random network initializations.

TABLE 4
Performance Comparison Between the Disclosed Method
and DeepTime in Multivariate Benchmarks

| | | Methods | | | |
|---|---|---|---|---|---|
| | | DeepTime | | DeepRRTime | |
| Metrics | | MSE | MAE | MSE | MAE |
| ETTm2 | 96 | 0.1658 ± 0.0009 | 0.2581 ± 0.0019 | 0.1656 ± 0.0008 | 0.2585 ± 0.0021 |
| | 192 | 0.2227 ± 0.0019 | 0.2994 ± 0.0015 | 0.2241 ± 0.0022 | 0.3004 ± 0.0029 |
| | 336 | 0.2778 ± 0.0049 | 0.3386 ± 0.0039 | 0.2764 ± 0.0025 | 0.3378 ± 0.0030 |
| | 720 | 0.3830 ± 0.0062 | 0.4114 ± 0.0056 | 0.3681 ± 0.0037 | 0.3970 ± 0.0048 |
| ECL | 96 | 0.1373 ± 0.0002 | 0.2381 ± 0.0004 | 0.1369 ± 0.0002 | 0.2375 ± 0.0003 |
| | 192 | 0.1523 ± 0.0004 | 0.2517 ± 0.0005 | 0.1517 ± 0.0003 | 0.2507 ± 0.0004 |
| | 336 | 0.1656 ± 0.0006 | 0.2677 ± 0.0009 | 0.1653 ± 0.0003 | 0.2669 ± 0.0004 |
| | 720 | 0.2015 ± 0.0002 | 0.3023 ± 0.0003 | 0.2018 ± 0.0004 | 0.3025 ± 0.0005 |
| Exchange | 96 | 0.0786 ± 0.0018 | 0.1993 ± 0.0035 | 0.0775 ± 0.0005 | 0.1974 ± 0.0006 |
| | 192 | 0.1519 ± 0.0015 | 0.2854 ± 0.0019 | 0.1528 ± 0.0032 | 0.2840 ± 0.0025 |
| | 336 | 0.3245 ± 0.0287 | 0.4241 ± 0.0190 | 0.2568 ± 0.0087 | 0.3752 ± 0.0041 |
| | 720 | 0.6751 ± 0.2371 | 0.5918 ± 0.1004 | 0.5411 ± 0.0664 | 0.5396 ± 0.0301 |
| Tr [symbol] | 96 | 0.3902 ± 0.0003 | 0.2744 ± 0.0005 | 0.3899 ± 0.0005 | 0.2738 ± 0.0004 |
| | 192 | 0.4016 ± 0.0004 | 0.2784 ± 0.0005 | 0.4018 ± 0.0004 | 0.2784 ± 0.0005 |
| | 336 | 0.4160 ± 0.0021 | 0.2885 ± 0.0019 | 0.4162 ± 0.0008 | 0.2854 ± 0.0006 |
| | 720 | 0.4505 ± 0.0006 | 0.3078 ± 0.0007 | 0.4502 ± 0.0008 | 0.3073 ± 0.0013 |
| Weather | 96 | 0.1667 ± 0.0012 | 0.2233 ± 0.0015 | 0.1661 ± 0.0006 | 0.2223 ± 0.0010 |
| | 192 | 0.2070 ± 0.0010 | 0.2603 ± 0.0014 | 0.2073 ± 0.0005 | 0.2603 ± 0.0007 |
| | 336 | 0.2522 ± 0.0010 | 0.3001 ± 0.0009 | 0.2510 ± 0.0011 | 0.2983 ± 0.0016 |
| | 720 | 0.3131 ± 0.0008 | 0.3501 ± 0.0011 | 0.3121 ± 0.0007 | 0.3481 ± 0.0016 |
| ILI | 24 | 2.5578 ± 0.1427 | 1.1151 ± 0.0357 | 2.3171 ± 0.1312 | 1.0437 ± 0.0486 |
| | 36 | 2.2642 ± 0.1279 | 1.0417 ± 0.0441 | 2.2527 ± 0.0597 | 1.0224 ± 0.0204 |
| | 48 | 2.3019 ± 0.1443 | 1.0270 ± 0.0315 | 2.2919 ± 0.1645 | 1.0330 ± 0.0419 |
| | 60 | 2.2921 ± 0.1186 | 1.0296 ± 0.0369 | 2.3014 ± 0.1531 | 1.0349 ± 0.0457 |

[symbol]

indicates data missing or illegible when filed

Moreover, the disclosed method achieved state-of-the-art performance on the challenging Exchange dataset and performed comparably with historical-value models on other datasets. PatchTST model may have a strong inductive bias that is very beneficial to modelling many types of time-series data. However, the disclosed method outperformed PatchTST by a large margin on the Exchange dataset, suggesting this same inductive bias can be counterproductive for some data types. The Exchange dataset is considered to be a very challenging LTSF benchmark due to its low signal-to-noise ratio and its low degree of stationarity. For reference, Table 5 below shows a summary of LTSF datasets with their ADF test statistics, where smaller ADF means a more stationary dataset. Further, Table 3A shows that the disclosed method outperformed the other Transformer-based historical-value models uniformly on ECL, Exchange, and Traffic, and on nearly all the ETTm2 metrics, although results are more mixed on Weather and ILI datasets.

TABLE 5
Summary of LTSF Datasets and the
Corresponding ADF Test Statistics

| | Number of | | | Number of | ADF test |
|---|---|---|---|---|---|
| Dataset | variables | Frequency | | samples | statistic |
| Exchange | 8 | 1 | Day | 7,588 | −1.889 |
| ILI | 7 | 1 | Week | 966 | −5.406 |
| ETTm2 | 7 | 15 | Minutes | 69,680 | −6.225 |
| ECL | 321 | 1 | Hour | 26,304 | −8.483 |
| Traffic | 862 | 1 | Hour | 17,544 | −15.046 |
| Weather | 21 | 10 | Minutes | 52,695 | −26.661 |

Accordingly, the experimental results demonstrated that the disclosed method can provide superior performance in forecasting, and that time-index models can be competitive with state-of-the-art historical-value models in at least some cases. Although PatchTST still exhibited an advantage in predictive performance on many LTSF datasets, it is also worth noting that time-index models have other practical advantages. For one, time-index models are generally less computationally expensive, especially during inference. For reference, Table 6 shows the computational costs of the disclosed method in comparison to PatchTST. Measurements include wall-clock time per epoch and peak memory usage in both train and inference modes when using PatchTST and the disclosed method as implemented on a single NVIDIA Tesla V™ GPU (16 GB). The disclosed method is observed as consistently faster than PatchTST in terms of both training and evaluation time and is more memory efficient on average. Additionally, a GPU out-of-memory error was observed for PatchTST on all forecast horizons of Traffic while there was no such issue for the disclosed method. As such, the disclosed method is much more efficient than PatchTST.

TABLE 6
Computation Efficiency Comparison Between the Disclosed Method and PatchTST

| | | Training | | Inference | |
|---|---|---|---|---|---|
| | | Peak memory | Time per epoch | Peak memory | Time per epoch |
| Dataset/Horizon | Model | (GB) ↓ | (s) ↓ | (GB) ↓ | (s) ↓ |
| Exchange/96 | DeepRRTime | 0.207 | 0.67 | 0.065 | 0.058 |
| | PatchTST | 0.449 | 3.68 | 0.153 | 1.45 |
| Exchange/720 | DeepRRTime | 2.98 | 1.88 | 0.774 | 0.257 |
| | PatchTST | 0.491 | 3.89 | 0.208 | 1.41 |
| ETTm2/96 | DeepRRTime | 1.05 | 6.39 | 0.448 | 1.43 |
| | PatchTST | 1.62 | 12.98 | 0.496 | 3.54 |
| ETTm2/720 | DeepRRTime | 1.48 | 8.13 | 1.32 | 2.8 |
| | PatchTST | 1.7 | 13.51 | 0.556 | 5.24 |
| Traffic/96 | DeepRRTime | 4.79 | 32.88 | 3.94 | 15.69 |
| | PatchTST | OOM | N/A | N/A | N/A |

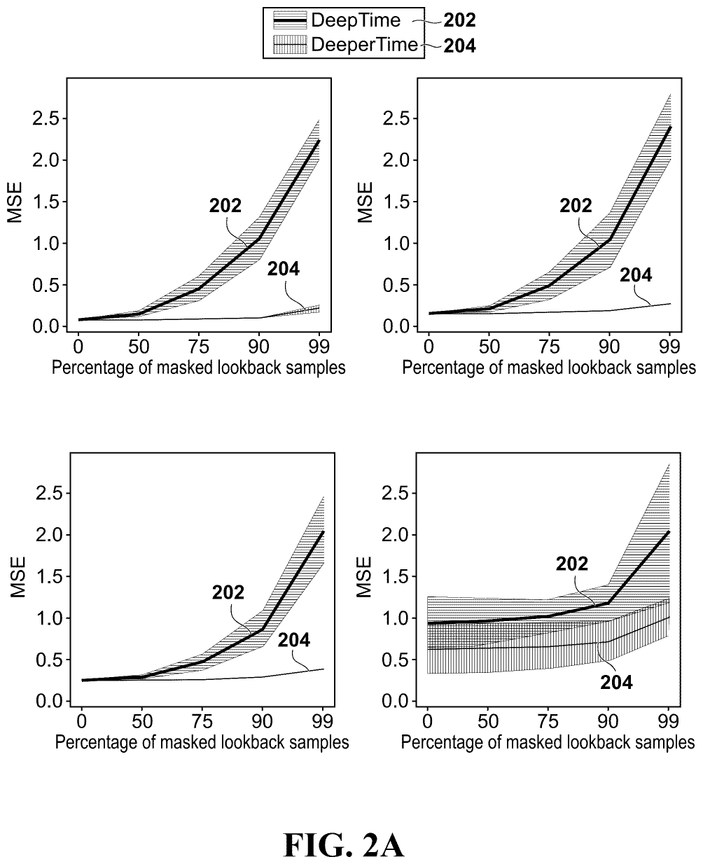

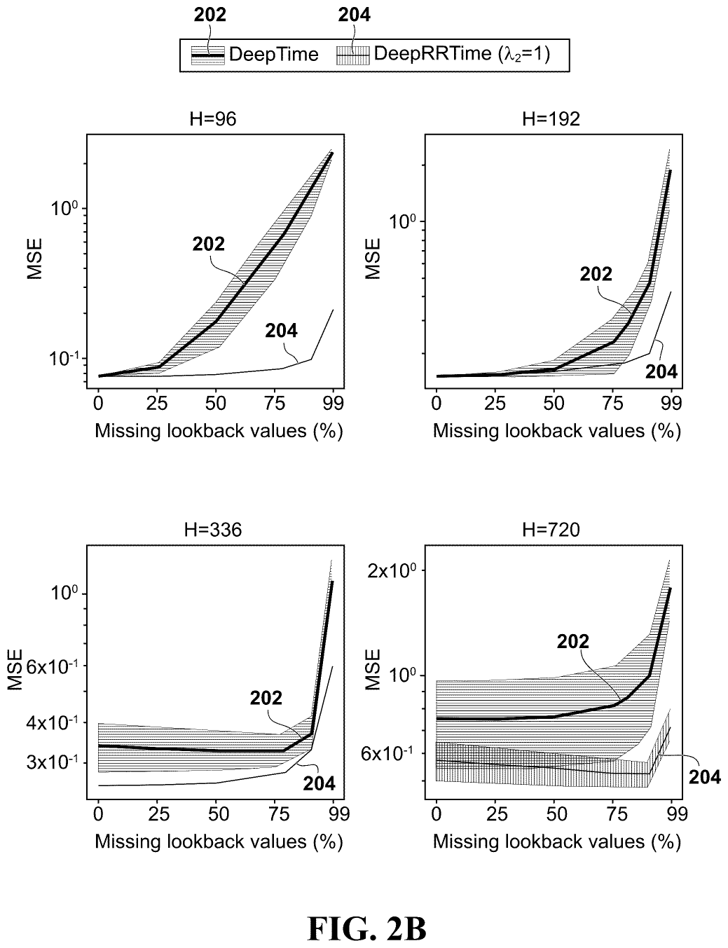

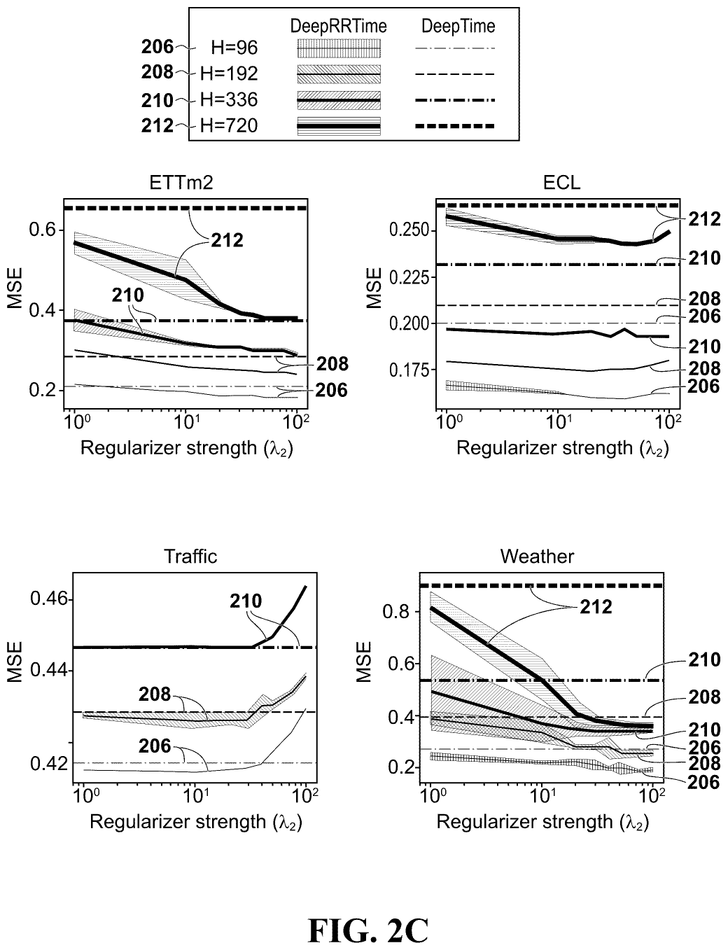

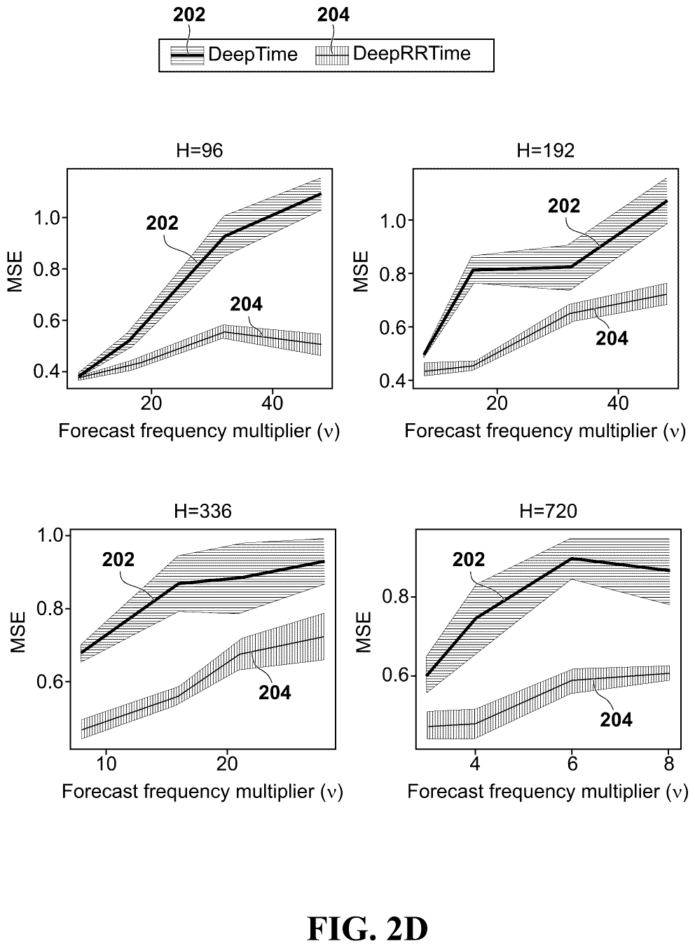

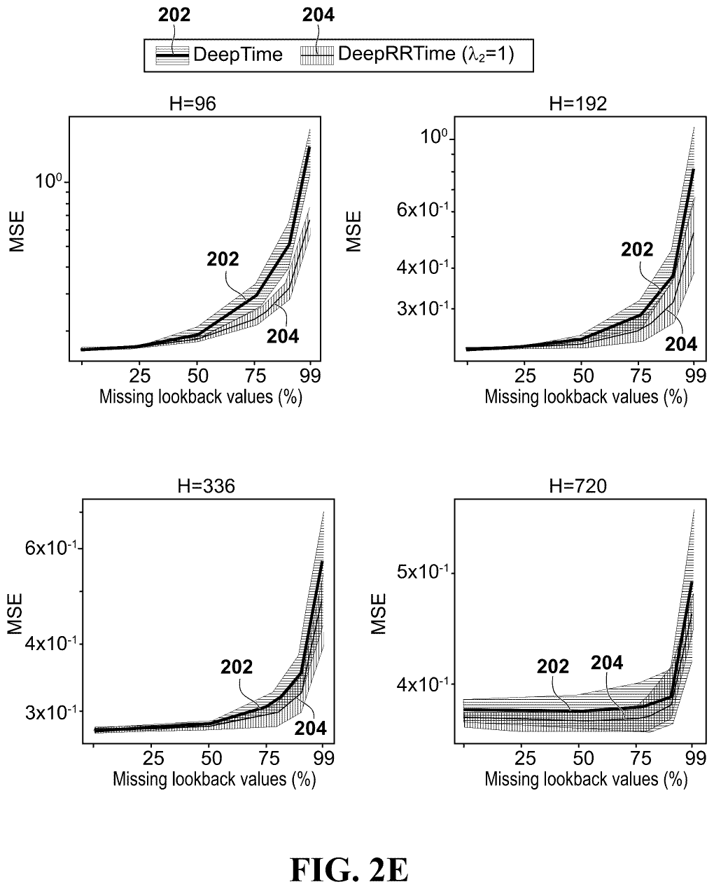

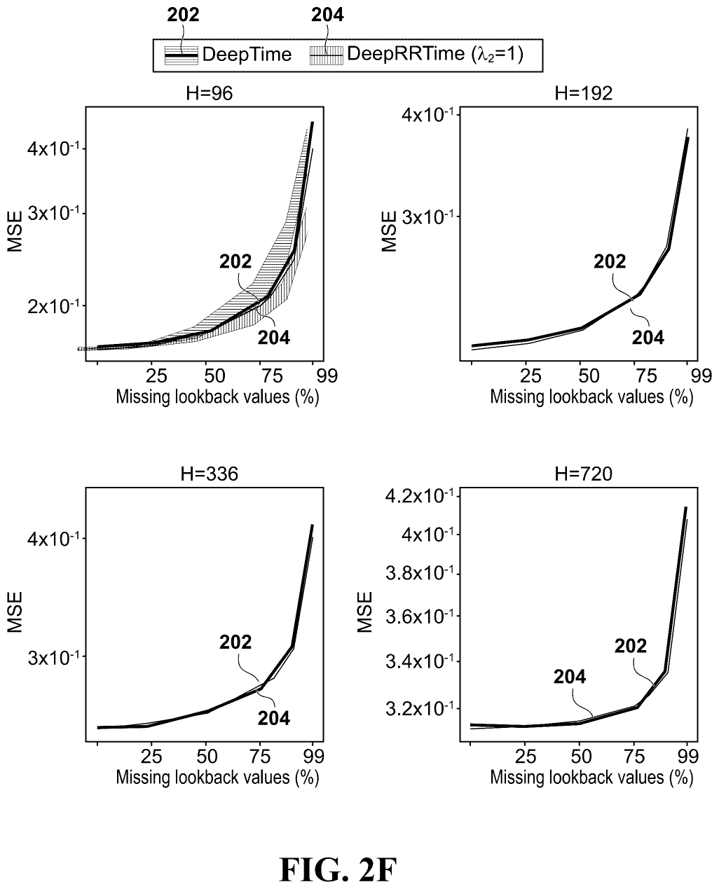

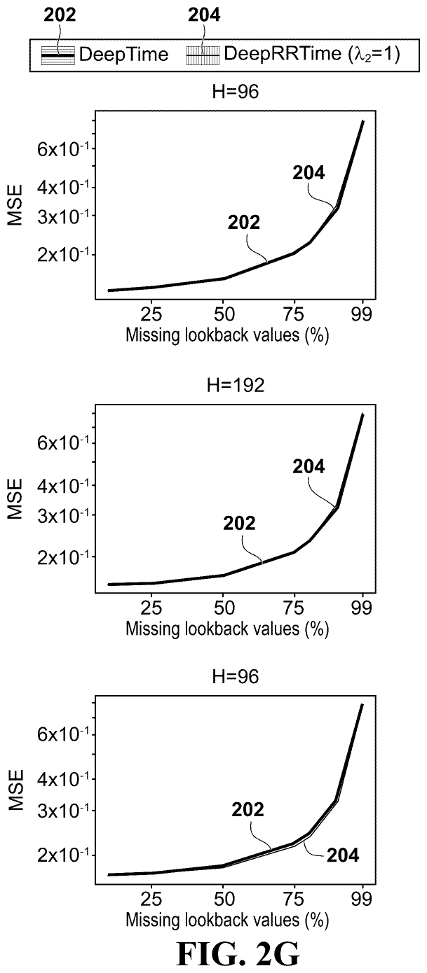

In some cases, only a marginal improvement is observed over the baseline and this may raise questions about the significance of these improvements. In order to clearly evaluate the benefits of the regularization, the following two experiments were conducted with fewer data. In the specific case of DeepTime, the performance can be evaluated with fewer data samples in the following two cases:
1. Lookback window has missing values. In this case, the models trained on regularly-sampled training data are evaluated on irregularly-sampled test-data: specifically, 50% of the samples in the lookback window are randomly masked out and only the remaining samples for computing the solutions W* and b* are used. The training and validation datasets are considered to have regularly sampled data—i.e., the same checkpoints evaluated in Table 1 are used except that the lookback windows for test-samples are randomly masked out. The results are shown in Table 7. Improvements in 36 out of 48 evaluations are present. On average, the relative percentage improvement in the MAE and MSE is 3.11% and 5.86% respectively. Notably, the highest improvement obtained is about 26.50% and 57.02% for MAE and MSE respectively. The effectiveness of the regularization considering higher masking-rates of 75% and 90% is highlighted in FIG. 2A. In summary, the results of this experiment highlight the robustness and potential of decorrelated basis obtained with the covariance regularization.
2. Fewer training samples. In this experiment, the models are trained with the last 10% of the training data. No optimization over the lookback multipliers is performed. The small datasets such as Exchange and ILI are not considered for this experiment—similarly, forecasting 720 samples with lookback multiplier 1 does not give the model sufficient training-data and this setting cannot be evaluated. The results are shown in Table 10. Improvements are observed in 23 out of 30 tested cases. Overall, a relative improvement of 4.17% and 7.29% is noted in terms of the MAE and MSE metrics respectively with the highest improvements going up to 13.07% and 21.89% respectively. For the ECL dataset, the forecasting performance decreases on applying the covariance regularization method 100. While the results are generally comparable for forecasting horizons of 192, 336 and 720 steps, a significant drop in performance is observed for the forecasting horizon of 96 time-steps. On average, the decrease in performance in the 7 cases is 2.49% and 6.05% for the MAE and MSE metrics respectively; when contrasted with the average improvements in 23 cases of about 7.51% MAE and 10.62% MSE, the covariance regularization method 100 is particularly beneficial in cases with smaller training data.

### Missing Values in the Lookback Window

In contrast to historical-value models, which typically assume a fixed lookback window, time-index models can, in principle, handle missing values in lookback windows without any extra architectural modifications even when trained with regularly-sampled training data (e.g. no missing values). As shown herein, although DeepTime is technically capable of making forecasts in spite of missing values, it does not perform very well in this setting. In contrast, the disclosed method can be robust in overcoming missing values in the lookback window, consistent with the expected advantages of learning a better-conditioned basis.

TABLE 7
Multivariate Forecasting with Missing Values in Lookback Window

| | | DeepTime | | Covariance Regularization Method 100 | |
|---|---|---|---|---|---|
| Data | Forecast | MAE | MSE | MAE | MSE |
| ECL | 96 | 0.2644 ± 0.0006 | 0.1555 ± 0.0003 | 0.2627 ± 0.0006 | 0.1549 ± 0.0003 |
| | 192 | 0.2739 ± 0.0002 | 0.1666 ± 0.0001 | 0.2732 ± 0.0004 | 0.1661 ± 0.0002 |
| | 336 | 0.2893 ± 0.0006 | 0.1805 ± 0.0004 | 0.2872 ± 0.0007 | 0.1792 ± 0.0005 |
| | 720 | 0.3190 ± 0.0004 | 0.2144 ± 0.0003 | 0.3183 ± 0.0001 | 0.2139 ± 0.0000 |
| ETTm2 | 96 | 0.3015 ± 0.0151 10 | 0.2009 ± 0.0129 10 | 0.2841 ± 0.0063 10 | 0.1835 ± 0.0047 10 |
| | 192 | 0.3153 ± 0.0087 10 | 0.2336 ± 0.0073 10 | 0.3120 ± 0.0060 10 | 0.2303 ± 0.0048 10 |
| | 336 | 0.3473 ± 0.0061 10 | 0.2824 ± 0.0063 10 | 0.3434 ± 0.0054 10 | 0.2787 ± 0.0044 10 |
| | 720 | 0.4145 ± 0.0067 10 | 0.3834 ± 0.0077 10 | 0.3946 ± 0.0030 3 | 0.3642 ± 0.0018 3 |
| Exchange | 96 | 0.2732 ± 0.0273 | 0.1831 ± 0.0566 | 0.2008 ± 0.0018 | 0.0787 ± 0.0008 |
| | 192 | 0.3154 ± 0.0254 | 0.1804 ± 0.0320 | 0.2926 ± 0.0080 | 0.1589 ± 0.0058 |
| | 336 | 0.4330 ± 0.0382 | 0.3360 ± 0.0582 | 0.3830 ± 0.0028 | 0.2621 ± 0.0033 |
| | 720 | 0.6637 ± 0.0706 | 0.8219 ± 0.1703 | 0.5605 ± 0.0336 | 0.5708 ± 0.0729 |
| ILI | 24 | 1.1105 ± 0.0546 | 2.5254 ± 0.2167 | 1.0576 ± 0.0258 | 2.3449 ± 0.0549 |
| | 36 | 1.0601 ± 0.0356 | 2.3912 ± 0.1215 | 1.0398 ± 0.0388 | 2.3414 ± 0.1019 |
| | 48 | 1.0554 ± 0.0608 | 2.3850 ± 0.2342 | 1.0347 ± 0.0216 | 2.3448 ± 0.0829 |
| | 60 | 1.0330 ± 0.0307 | 2.3256 ± 0.1451 | 1.0375 ± 0.0422 | 2.3242 ± 0.1348 |
| Traffic | 96 | 0.2951 ± 0.0007 10 | 0.4174 ± 0.0005 10 | 0.2937 ± 0.0005 8 | 0.4172 ± 0.0007 8 |
| | 192 | 0.2973 ± 0.0004 10 | 0.4246 ± 0.0005 10 | 0.2954 ± 0.0003 4 | 0.4228 ± 0.0005 4 |
| | 336 | 0.3171 ± 0.0005 10 | 0.4722 ± 0.0005 10 | 0.3005 ± 0.0005 6 | 0.4354 ± 0.0003 6 |
| | 720 | | | | |
| Weather | 96 | 0.2423 ± 0.0016 10 | 0.1766 ± 0.0012 10 | 0.2431 ± 0.0023 10 | 0.1778 ± 0.0013 10 |
| | 192 | 0.2758 ± 0.0019 10 | 0.2168 ± 0.0017 10 | 0.2772 ± 0.0007 10 | 0.2184 ± 0.0006 10 |
| | 336 | 0.3146 ± 0.0012 10 | 0.2620 ± 0.0016 10 | 0.3134 ± 0.0016 2 | 0.2600 ± 0.0013 2 |
| | 720 | 0.3598 ± 0.0013 6 | 0.3184 ± 0.0010 6 | 0.3558 ± 0.0015 4 | 0.3161 ± 0.0014 4 |

A further example is shown in Tables 8A and 8B, comparing the performance of DeepTime and the disclosed method in settings of missing values in lookback window and no missing values in lookback window.

TABLE 8A
Performance Comparison Between the Disclosed Method
and DeepTime for Missing Values in Lookback Window

| | | Methods | | | | | |
|---|---|---|---|---|---|---|---|
| | | 50% missing lookback values | | | | No missing values | |
| | | DeepTime | | DeepRRTime | | DeepRRTime | |
| Metrics | | MSE | MAE | MSE | MAE | MSE | MAE |
| ETTm2 | 96 | 0.200 | 0.301 | 0.183 | 0.284 | 0.165 | 0.258 |
| | 192 | 0.233 | 0.315 | 0.230 | 0.312 | 0.224 | 0.300 |
| | 336 | 0.282 | 0.347 | 0.278 | 0.343 | 0.276 | 0.337 |
| | 720 | 0.383 | 0.414 | 0.363 | 0.394 | 0.368 | 0.397 |
| ECL | 96 | 0.155 | 0.263 | 0.154 | 0.262 | 0.136 | 0.237 |
| | 192 | 0.166 | 0.274 | 0.165 | 0.272 | 0.151 | 0.250 |
| | 336 | 0.180 | 0.289 | 0.179 | 0.287 | 0.165 | 0.266 |
| | 720 | 0.215 | 0.319 | 0.214 | 0.319 | 0.201 | 0.302 |
| Exchange | 96 | 0.175 | 0.268 | 0.081 | 0.205 | 0.077 | 0.197 |
| | 192 | 0.166 | 0.303 | 0.158 | 0.292 | 0.152 | 0.284 |
| | 336 | 0.311 | 0.416 | 0.259 | 0.379 | 0.256 | 0.375 |
| | 720 | 0.665 | 0.593 | 0.516 | 0.532 | 0.541 | 0.539 |
| Traffic | 96 | 0.417 | 0.295 | 0.417 | 0.293 | 0.389 | 0.273 |
| | 192 | 0.424 | 0.297 | 0.422 | 0.295 | 0.401 | 0.278 |
| | 336 | 0.438 | 0.305 | 0.435 | 0.300 | 0.416 | 0.285 |
| | 720 | 0.475 | 0.325 | 0.473 | 0.322 | 0.450 | 0.307 |
| Weather | 96 | 0.176 | 0.242 | 0.177 | 0.243 | 0.166 | 0.222 |
| | 192 | 0.216 | 0.275 | 0.218 | 0.277 | 0.207 | 0.260 |
| | 336 | 0.262 | 0.314 | 0.260 | 0.312 | 0.251 | 0.298 |
| | 720 | 0.318 | 0.359 | 0.316 | 0.357 | 0.312 | 0.348 |
| ILI | 24 | 2.571 | 1.120 | 2.395 | 1.076 | 2.317 | 1.043 |
| | 36 | 2.309 | 1.046 | 2.291 | 1.033 | 2.252 | 1.022 |
| | 48 | 2.352 | 1.032 | 2.344 | 1.039 | 2.291 | 1.033 |
| | 60 | 2.328 | 1.033 | 2.341 | 1.039 | 2.301 | 1.034 |

TABLE 8B
Performance Comparison Between the Disclosed Method and DeepTime for Missing
Values in Lookback Window Showing Additional Significant Digits

| | | Methods | | | |
|---|---|---|---|---|---|
| | | DeepTime | | DeepRRTime | |
| Metrics | | MSE | MAE | MSE | MAE |
| ETTm2 | 96 | 0.2009 ± 0.0129 | 0.3015 ± 0.0151 | 0.1835 ± 0.0047 | 0.2841 ± 0.0063 |
| | 192 | 0.2336 ± 0.0073 | 0.3153 ± 0.0087 | 0.2303 ± 0.0048 | 0.3120 ± 0.0060 |
| | 336 | 0.2824 ± 0.0063 | 0.3473 ± 0.0061 | 0.2787 ± 0.0044 | 0.3434 ± 0.0054 |
| | 720 | 0.3834 ± 0.0077 | 0.4145 ± 0.0067 | 0.3634 ± 0.0028 | 0.3942 ± 0.0042 |
| E [symbol] | 96 | 0.1551 ± 0.0005 | 0.2638 ± 0.0006 | 0.1545 ± 0.0005 | 0.2620 ± 0.0009 |
| | 192 | 0.1667 ± 0.0006 | 0.2740 ± 0.0008 | 0.1659 ± 0.0004 | 0.2727 ± 0.0006 |
| | 336 | 0.1808 ± 0.0005 | 0.2897 ± 0.0007 | 0.1791 ± 0.0004 | 0.2870 ± 0.0007 |
| | 720 | 0.2150 ± 0.0003 | 0.3197 ± 0.0004 | 0.2146 ± 0.0005 | 0.3192 ± 0.0006 |
| Exchange | 96 | 0.1750 ± 0.0696 | 0.2683 ± 0.0406 | 0.0811 ± 0.0007 | 0.2052 ± 0.0013 |
| | 192 | 0.1668 ± 0.0106 | 0.3037 ± 0.0087 | 0.1582 ± 0.0046 | 0.2927 ± 0.0052 |
| | 336 | 0.3114 ± 0.0315 | 0.4162 ± 0.0228 | 0.2594 ± 0.0091 | 0.3797 ± 0.0044 |
| | 720 | 0.6655 ± 0.1931 | 0.5937 ± 0.0848 | 0.5168 ± 0.0593 | 0.5320 ± 0.0291 |
| Traffic | 96 | 0.4174 ± 0.0005 | 0.2951 ± 0.0007 | 0.4172 ± 0.0007 | 0.2937 ± 0.0004 |
| | 192 | 0.4246 ± 0.0005 | 0.2973 ± 0.0004 | 0.4229 ± 0.0004 | 0.2955 ± 0.0003 |
| | 336 | 0.4385 ± 0.0007 | 0.3054 ± 0.0007 | 0.4354 ± 0.0004 | 0.3005 ± 0.0005 |
| | 720 | 0.4759 ± 0.0011 | 0.3250 ± 0.0011 | 0.4730 ± 0.0048 | 0.3223 ± 0.0044 |
| Weather | 96 | 0.1766 ± 0.0012 | 0.2423 ± 0.0016 | 0.1778 ± 0.0013 | 0.2431 ± 0.0023 |
| | 192 | 0.2168 ± 0.0017 | 0.2758 ± 0.0019 | 0.2184 ± 0.0006 | 0.2772 ± 0.0007 |
| | 336 | 0.2620 ± 0.0016 | 0.3146 ± 0.0012 | 0.2607 ± 0.0020 | 0.3127 ± 0.0028 |
| | 720 | 0.3183 ± 0.0008 | 0.3596 ± 0.0012 | 0.3168 ± 0.0014 | 0.3570 ± 0.0023 |
| ILI | 24 | 2.5713 ± 0.1238 | 1.1205 ± 0.0255 | 2.3953 ± 0.1274 | 1.0760 ± 0.0493 |
| | 36 | 2.3090 ± 0.1166 | 1.0469 ± 0.0430 | 2.2915 ± 0.0495 | 1.0338 ± 0.0173 |
| | 48 | 2.3526 ± 0.1320 | 1.0326 ± 0.0294 | 2.3446 ± 0.1482 | 1.0395 ± 0.0407 |
| | 60 | 2.3287 ± 0.0835 | 1.0335 ± 0.0283 | 2.3414 ± 0.1340 | 1.0397 ± 0.0411 |

[symbol]

indicates data missing or illegible when filed

As shown in Tables 8A and 8B, the disclosed method is more resilient to this test than DeepTime on all datasets except Weather; on the shortest two horizons of Weather, the disclosed method underperforms DeepTime by a statistically significant but nonetheless small amount. Importantly, the missing value experiment can reveal differences between DeepTime and the disclosed method that were not evident in the regular forecasting setup. It is observed that the difference between DeepTime and the disclosed method widens in the missing-value setting as compared to the default setting: examples where average MSE improves are ECL (0.15%→0.50%), Traffic (0.000%→0.44%), ETTm2 (1.05%→4.15%) and Exchange (10.28%→24.46%). Based on the Welch's one-sided t-test, the disclosed method achieved statistically significant improvements in 30 out of 40 metrics on the missing-value test. Further, the state-of-the-art performance of the disclosed method on the longer forecasting horizons of Exchange barely degraded at all, compared to its performance without masked inputs, illustrating the robustness conferred by the disclosed method.

Plots of MSE of the disclosed method and DeepTime with missing rates of 25%, 50%, 75%, 90%, and 99% on the Exchange dataset are shown in FIG. 2B, where trendlines of DeepTime and the disclosed method are shown as 202 and 204, respectively. The plots show that while the MSE of DeepTime grows up to an order of magnitude with increasing masking rate, the disclosed method exhibited little degradation even when 90% of the lookback values are missing. FIGS. 2E-2G respectively depict the MSE plots of the disclosed method and DeepTime as functions of missing lookback values percentage for different forecast horizons on ETTm2 (FIG. 2E), Weather (FIG. 2F) and ECL (FIG. 2G) datasets. Trendlines of DeepTime and the disclosed method are shown as 202 and 204, respectively. The shaded areas show standard deviations over 3 network initializations. For the ETTm2 dataset, the performance of DeepTime deteriorated more significantly for higher missing rates than the disclosed method.

Accordingly, the added regularization at block 110 can enable robust forecasting in the presence of missing lookback values. While this can be a putative advantage of time-index models over historical-value models, the DeepTime model does not actually perform stably in this setting. Further, most historical-value models, including PatchTST, cannot natively operate with lookback window samples that differ from the exact sequence on which they were trained. Referring to Table 9, an evaluation of Patch-TST with missing-values using linear-interpolation/zero-substitution to handle missing values is shown. As shown in Table 9, the forward evaluation of these models is simply undefined for sequences of a different length. Two techniques were used to enable PatchTST forecasting with missing values: (a) replacing missing values with 0, and (b) linear interpolation. While a significant drop of performance for PatchTST with both techniques were observed, the disclosed method remained robust on this challenging setting, which highlights its advantage over historical-valued models. Best results with the missing values are highlighted in bold. Table 9 shows means and standard deviations over 10 network initializations. The robustness of the disclosed method to missing samples in the lookback window can be useful in certain real-world scenarios where only irregularly sampled values are available during inference.

TABLE 9
Comparison of the Disclosed Method with PatchTST on ETTm2 with 50% of Lookback Values Missing

| | No missing lookback values | | | | 50% missing lookback values | |
|---|---|---|---|---|---|---|
| | PatchTST | | DeepRRTime | | PatchTST (replace with 0) | |
| H | MSE | MAE | MSE | MAE | MSE | MAE |
| 96 | 0.1651 ± 0.0010 | 0.2533 ± 0.0011 | 0.1656 ± 0.0008 | 0.2585 ± 0.0021 | 0.9213 ± 0.0580 | 0.6990 ± 0.0211 |
| 192 | 0.2220 ± 0.0009 | 0.2933 ± 0.0007 | 0.2241 ± 0.0022 | 0.3004 ± 0.0029 | 0.9943 ± 0.0253 | 0.7245 ± 0.0096 |
| 336 | 0.2762 ± 0.0009 | 0.3289 ± 0.0007 | 0.2764 ± 0.0025 | 0.3378 ± 0.0030 | 1.0337 ± 0.0247 | 0.7372 ± 0.0077 |
| 720 | 0.3654 ± 0.0013 | 0.3837 ± 0.0006 | 0.3681 ± 0.0037 | 0.3970 ± 0.0048 | 1.0436 ± 0.0446 | 0.7378 ± 0.0160 |

| | 50% missing lookback values | | | |
|---|---|---|---|---|
| | PatchTST (linear interpolation) | | DeepRRTime | |
| H | MSE | MAE | MSE | MAE |
| 96 | 0.6411 ± 0.0478 | 0.5039 ± 0.0157 | 0.1835 ± 0.0047 | 0.2841 ± 0.0063 |
| 192 | 0.5564 ± 0.0388 | 0.4830 ± 0.0141 | 0.2303 ± 0.0048 | 0.3120 ± 0.0060 |
| 336 | 0.5265 ± 0.0417 | 0.4761 ± 0.0160 | 0.2787 ± 0.0044 | 0.3434 ± 0.0054 |
| 720 | 0.5748 ± 0.0696 | 0.5026 ± 0.0268 | 0.3634 ± 0.0028 | 0.3942 ± 0.0042 |

### Smaller Training Dataset Size

Results for smaller training dataset size is shown below in Table 10.

TABLE 10
Results with Last 10% of Training Data

| | | DeepTime | | Covariance Regularization Method 100 | |
|---|---|---|---|---|---|
| Data | Forecast | MAE | MSE | MAE | MSE |
| ECL | 96 | 0.5267 ± 0.0210 | 6.8423 ± 0.8836 | 0.5823 ± 0.0289 | 7.9393 ± 1.5896 |
| | 192 | 0.4417 ± 0.0051 | 4.0853 ± 0.0347 | 0.4446 ± 0.0053 | 4.1368 ± 0.0260 |
| | 336 | 0.4665 ± 0.0008 | 5.5961 ± 0.0076 | 0.4711 ± 0.0022 | 5.5654 ± 0.0284 |
| | 720 | 1.0573 ± 0.0071 | 13.1370 ± 0.2322 | 1.0575 ± 0.0005 | 12.9651 ± 0.0605 |
| ETTm2 | 96 | 0.6650 ± 0.0263 | 0.8867 ± 0.0645 | 0.6319 ± 0.0323 | 0.7993 ± 0.0718 |
| | 192 | 0.7921 ± 0.0354 | 1.2542 ± 0.1039 | 0.7218 ± 0.0451 | 1.0599 ± 0.1153 |
| | 336 | 0.9051 ± 0.0576 | 1.6436 ± 0.1964 | 0.8148 ± 0.0405 | 1.3531 ± 0.1280 |
| | 720 | 0.8918 ± 0.1281 | 1.6034 ± 0.4729 | 0.8633 ± 0.0708 | 1.4740 ± 0.2339 |
| Traffic | 96 | 0.4130 ± 0.0019 2 | 0.6958 ± 0.0020 2 | 0.4030 ± 0.0145 5 | 0.6894 ± 0.0156 5 |
| | 192 | 0.3603 ± 0.0050 10 | 0.5345 ± 0.0085 10 | 0.3675 ± 0.0036 10 | 0.5447 ± 0.0065 10 |
| | 336 | 0.7277 ± 0.1125 10 | 1.2648 ± 0.2369 10 | 0.7246 ± 0.1251 10 | 1.2565 ± 0.2644 10 |
| | 720 | | | | |
| Weather | 96 | 0.5005 ± 0.0191 | 0.5359 ± 0.0301 | 0.4919 ± 0.0229 | 0.5113 ± 0.0368 |
| | 192 | 0.6447 ± 0.0199 | 0.8092 ± 0.0418 | 0.5970 ± 0.0374 | 0.7162 ± 0.0715 |
| | 336 | 0.7938 ± 0.0358 | 1.1996 ± 0.0978 | 0.7194 ± 0.0187 | 1.0080 ± 0.0467 |
| | 720 | 0.7904 ± 0.0711 | 1.2103 ± 0.1680 | 0.6812 ± 0.0456 | 0.9609 ± 0.0894 |

A further example is shown in Table 11. As reducing dataset size leads to reduced updates per epoch as compared to the default training scenario, the number of epochs, early-stopping patience and warmup epochs were increased by 10×. The data was normalized using mean and standard deviation statistics estimated using the reduced training dataset. To obtain error metrics comparable to the other settings, MSE and MAE obtained by renormalizing model outputs using statistics estimated using the full training dataset were used. The disclosed method was evaluated by selecting λ₂ from {1, 10, 25, 50, 75, 100} based on the validation loss.

Table 11 shows a comparison between the disclosed method and DeepTime when trained on 10% of data for the settings without missing lookback values and with 50% of lookback values missing. As observed in Table 11, DeepTime experienced a significant performance drop when trained on reduced datasets. In contrast, the disclosed method considerably narrowed this performance gap, and outperformed DeepTime by approximately 20%. An average MSE increase of 11.8% with reduced dataset sizes is observed, as compared to a 30% increase in the case of DeepTime. A similar trend is observed for forecasting with missing lookback values.

TABLE 11
Performance Comparison Between the Disclosed Method
and DeepTime Trained using 10% of the Data

| | Methods | | | | | |
|---|---|---|---|---|---|---|
| | 10% of data | | | | Full data | |
| | DeepTime | | DeepRRTime | | DeepRRTime | |
| Metrics | MSE | MAE | MSE | MAE | MSE | MAE |

(a) No missing lookback values

| | | | | | | | |
|---|---|---|---|---|---|---|---|
| ETTm2 | 96 | 0.210 | 0.306 | 0.181 | 0.276 | 0.165 | 0.258 |
| | 192 | 0.285 | 0.357 | 0.241 | 0.313 | 0.224 | 0.300 |
| | 336 | 0.374 | 0.412 | 0.301 | 0.351 | 0.276 | 0.337 |
| | 720 | 0.653 | 0.566 | 0.379 | 0.403 | 0.368 | 0.397 |
| ECL | 96 | 0.200 | 0.313 | 0.159 | 0.260 | 0.136 | 0.237 |
| | 192 | 0.209 | 0.323 | 0.175 | 0.276 | 0.151 | 0.250 |
| | 336 | 0.231 | 0.343 | 0.193 | 0.292 | 0.165 | 0.266 |
| | 720 | 0.264 | 0.365 | 0.249 | 0.342 | 0.201 | 0.302 |
| Traffic | 96 | 0.414 | 0.288 | 0.411 | 0.283 | 0.389 | 0.273 |
| | 192 | 0.428 | 0.302 | 0.425 | 0.299 | 0.401 | 0.278 |
| | 336 | 0.446 | 0.298 | 0.446 | 0.295 | 0.416 | 0.285 |
| Weather | 96 | 0.273 | 0.346 | 0.188 | 0.252 | 0.166 | 0.222 |
| | 192 | 0.394 | 0.435 | 0.256 | 0.317 | 0.207 | 0.260 |
| | 336 | 0.535 | 0.509 | 0.344 | 0.388 | 0.251 | 0.298 |
| | 720 | 0.900 | 0.713 | 0.357 | 0.380 | 0.312 | 0.348 |

(b) 50% missing lookback values

| | | | | | | | |
|---|---|---|---|---|---|---|---|
| ETTm2 | 96 | 0.214 | 0.309 | 0.180 | 0.277 | 0.183 | 0.284 |
| | 192 | 0.287 | 0.359 | 0.239 | 0.312 | 0.230 | 0.312 |
| | 336 | 0.374 | 0.412 | 0.399 | 0.350 | 0.278 | 0.343 |
| | 720 | 0.652 | 0.565 | 0.376 | 0.400 | 0.363 | 0.394 |
| ECL | 96 | 0.217 | 0.330 | 0.181 | 0.290 | 0.154 | 0.262 |
| | 192 | 0.217 | 0.331 | 0.192 | 0.299 | 0.165 | 0.272 |
| | 336 | 0.240 | 0.351 | 0.220 | 0.325 | 0.179 | 0.287 |
| | 720 | 0.270 | 0.370 | 0.259 | 0.352 | 0.214 | 0.319 |
| Traffic | 96 | 0.438 | 0.303 | 0.435 | 0.300 | 0.417 | 0.293 |
| | 192 | 0.448 | 0.315 | 0.445 | 0.312 | 0.422 | 0.295 |
| | 336 | 0.473 | 0.316 | 0.472 | 0.313 | 0.435 | 0.300 |
| Weather | 96 | 0.313 | 0.389 | 0.185 | 0.249 | 0.177 | 0.243 |
| | 192 | 0.425 | 0.464 | 0.237 | 0.293 | 0.218 | 0.277 |
| | 336 | 0.543 | 0.518 | 0.317 | 0.364 | 0.260 | 0.312 |
| | 720 | 0.886 | 0.710 | 0.346 | 0.370 | 0.316 | 0.357 |

FIG. 2C depicts the performance of the disclosed method on every dataset for different values of λ₂ varying from λ₂=0 (e.g. no regularization, corresponding to DeepTime) to λ₂=100. In FIG. 2C, solid and dashed trendlines correspond to the disclosed method the DeepTime, respectively. Trendlines labeled as 206, 208, 210, and 210 respectively correspond to values of H being 96, 192, 336, and 720. As shown in FIG. 2C, in most cases, tuning λ₂ for a specific problem can improve performance. Based on these results, regularization at block 110 is particularly likely to add value over the unregularized DeepTime when training on relatively small training datasets.

A summary of the improvements of the disclosed method over DeepTime is shown in Table 12 including all combinations of training (e.g. full-data vs 10% of training data) and evaluation (e.g. 50% missing lookback values vs no missing values). As shown in Table 12, regularization at block 110 introduced higher improvements for more challenging settings of train and/or evaluation. For each dataset, results were averaged over 4 forecast horizons. Average and highest relative improvements in terms of MSE and MAE are shown.

TABLE 12
Summary of Improvements for the Disclosed Method

| | | Evaluation | | | | | | | |
|---|---|---|---|---|---|---|---|---|---|
| | | No missing values | | | | 50% missing lookback values | | | |
| | | Average improvement | | Highest improvement | | Average improvement | | Highest improvement | |
| Train portion | Data | MSE | MAE | MSE | MAE | MSE | MAE | MSE | MAE |
| Full | ETTm2 | 1.05% | 0.84% | 3.92% | 3.41% | 4.15% | 3.21% | 8.66% | 5.77% |
| | ECL | 0.15% | 0.11% | 0.60% | 0.40% | 0.50% | 0.56% | 0.94% | 0.93% |
| | Exchange | 10.28% | 5.42% | 20.68% | 11.56% | 24.46% | 11.58% | 53.66% | 23.52% |
| | Traffic | 0.00% | 0.43% | 0.00% | 1.38% | 0.44% | 0.88% | 0.71% | 1.60% |
| | Weather | 0.33% | 0.42% | 0.60% | 0.67% | −0.11% | 0.12% | 0.50% | 0.72% |
| | ILI | 2.49% | 1.80% | 9.42% | 6.37% | 1.85% | 0.99% | 6.84% | 3.97% |
| 10% of data | ETTm2 | 22.65% | 16.39% | 41.94% | 28.80% | 23.75% | 16.92% | 42.33% | 29.20% |
| | ECL | 14.64% | 13.07% | 20.40% | 16.96% | 10.13% | 8.52% | 16.59% | 12.12% |
| | Traffic | 0.43% | 1.21% | 0.65% | 1.94% | 0.52% | 0.96% | 0.68% | 0.99% |
| | Weather | 40.53% | 31.11% | 60.36% | 46.70% | 46.92% | 37.62% | 60.95% | 47.89% |

Improvements over DeepTime are evaluated by considering the last column in each dataset as the target variate (e.g. last variable of 2 multivariate datasets). Exchange and ETTm2 datasets were used. Lookback-multipliers are fixed to 1 for these experiments: the results are included in Table 13A. Similar to the multivariate forecasting case, results with missing values are also included in the lookback window in Table 13B to clearly evaluate the benefits of the regularization. Overall, the regularization improves in 19 cases when there are no missing values in the lookback window while improving in 29 cases when there are missing values in the lookback window. In the case where no missing values are in the lookback window, the regularization makes little difference on average and in fact decreases the performance by 0.41% MAE and 0.67% on average. Specifically, the average decrease in performance is 3.60% MAE and 4.97% MSE in contrast to average increase that corresponds to 3.36% MAE and 6.68% MSE. When observations are masked in the lookback window, MAE and MSE improve by 2.22% and 4.72% on average. Specifically, in the 19 cases where the performance decreases, an average drop of 5.28% MAE and 7.44% MSE is observed as compared to an average increase of 6.72% MAE and 12.88% MSE in the 29 cases. While the improvements in univariate case are not as impressive as in the multivariate case, several benefits of regularization are still observed.

TABLE 13A
Univariate Forecasting

| | | DeepTime | | DeepRRTime | |
|---|---|---|---|---|---|
| Data | Forecast | MAE | MSE | MAE | MSE |
| ECL | 96 | 0.4385 ± 0.0003 | 0.3741 ± 0.0004 | 0.4381 ± 0.0007 | 0.3731 ± 0.0007 |
| | 192 | 0.3569 ± 0.0001 | 0.2568 ± 0.0003 | 0.3583 ± 0.0007 | 0.2583 ± 0.0008 |
| | 336 | 0.3666 ± 0.0003 | 0.2705 ± 0.0003 | 0.3673 ± 0.0015 | 0.2711 ± 0.0014 |
| | 720 | 0.3963 ± 0.0035 | 0.2944 ± 0.0045 | 0.3989 ± 0.0017 | 0.2979 ± 0.0019 |
| ETTm2 | 96 | 0.1938 ± 0.0011 | 0.0715 ± 0.0006 | 0.1924 ± 0.0008 | 0.0710 ± 0.0004 |
| | 192 | 0.2312 ± 0.0009 | 0.0957 ± 0.0007 | 0.2321 ± 0.0011 | 0.0965 ± 0.0007 |
| | 336 | 0.2637 ± 0.0017 | 0.1204 ± 0.0012 | 0.2647 ± 0.0009 | 0.1211 ± 0.0008 |
| | 720 | 0.3281 ± 0.0016 | 0.1777 ± 0.0015 | 0.3267 ± 0.0026 | 0.1768 ± 0.0028 |
| Exchange | 96 | 0.2250 ± 0.0023 | 0.0854 ± 0.0009 | 0.2279 ± 0.0028 | 0.0869 ± 0.0016 |
| | 192 | 0.3308 ± 0.0033 | 0.1733 ± 0.0025 | 0.3290 ± 0.0019 | 0.1744 ± 0.0022 |
| | 336 | 0.4584 ± 0.0063 | 0.3203 ± 0.0102 | 0.4434 ± 0.0044 | 0.3026 ± 0.0052 |
| | 720 | 0.7276 ± 0.0692 | 0.8109 ± 0.1131 | 0.6881 ± 0.0871 | 0.7387 ± 0.1546 |
| ILI | 24 | 0.8053 ± 0.0134 | 1.0366 ± 0.0302 | 0.8318 ± 0.0087 | 1.1094 ± 0.0253 |
| | 36 | 0.8751 ± 0.0217 | 1.0345 ± 0.0354 | 0.8774 ± 0.0212 | 1.0453 ± 0.0388 |
| | 48 | 0.9477 ± 0.0117 | 1.1102 ± 0.0200 | 0.9276 ± 0.0198 | 1.0799 ± 0.0294 |
| | 60 | 0.7612 ± 0.0678 | 0.8615 ± 0.0972 | 0.8357 ± 0.0582 | 0.9576 ± 0.0950 |
| Traffic | 96 | 0.3879 ± 0.0071 10 | 0.2952 ± 0.0037 10 | 0.3693 ± 0.0078 10 | 0.2768 ± 0.0044 10 |
| | 192 | 0.2137 ± 0.0006 10 | 0.1416 ± 0.0002 10 | 0.2150 ± 0.0007 10 | 0.1419 ± 0.0002 10 |
| | 336 | 0.2041 ± 0.0002 3 | 0.1247 ± 0.0001 3 | 0.2047 ± 0.0007 2 | 0.1248 ± 0.0001 2 |
| | 720 | 0.2185 ± 0.0021 10 | 0.1348 ± 0.0009 10 | 0.2209 ± 0.0018 10 | 0.1358 ± 0.0009 10 |
| Weather | 96 | 0.0459 ± 0.0107 | 0.0036 ± 0.0014 | 0.0487 ± 0.0054 | 0.0038 ± 0.0007 |
| | 192 | 0.0388 ± 0.0110 | 0.0027 ± 0.0014 | 0.0344 ± 0.0096 | 0.0022 ± 0.0011 |
| | 336 | 0.0279 ± 0.0003 | 0.0014 ± 0.0001 | 0.0277 ± 0.0006 | 0.0014 ± 0.0001 |
| | 720 | 0.0347 ± 0.0008 | 0.0022 ± 0.0002 | 0.0345 ± 0.0011 | 0.0022 ± 0.0002 |

TABLE 13B
Univariate Forecasting with Missing Values in Lookback Window

| | | DeepTime | | DeepRRTime | |
|---|---|---|---|---|---|
| Data | Forecast | MAE | MSE | MAE | MSE |
| ECL | 96 | 0.4646 ± 0.0003 | 0.4018 ± 0.0012 | 0.4714 ± 0.0011 | 0.4129 ± 0.0014 |
| | 192 | 0.3677 ± 0.0004 | 0.2663 ± 0.0005 | 0.3743 ± 0.0005 | 0.2743 ± 0.0006 |
| | 336 | 0.3724 ± 0.0003 | 0.2758 ± 0.0004 | 0.3751 ± 0.0011 | 0.2797 ± 0.0012 |
| | 720 | 0.3979 ± 0.0037 | 0.2949 ± 0.0050 | 0.4012 ± 0.0016 | 0.2986 ± 0.0019 |
| ETTm2 | 96 | 0.2353 ± 0.0056 | 0.0986 ± 0.0046 | 0.2073 ± 0.0016 | 0.0777 ± 0.0008 |
| | 192 | 0.2663 ± 0.0057 | 0.1221 ± 0.0053 | 0.2449 ± 0.0022 | 0.1038 ± 0.0015 |
| | 336 | 0.2881 ± 0.0065 | 0.1393 ± 0.0058 | 0.2712 ± 0.0022 | 0.1251 ± 0.0020 |
| | 720 | 0.3341 ± 0.0018 | 0.1825 ± 0.0018 | 0.3310 ± 0.0028 | 0.1797 ± 0.0031 |
| Exchange | 96 | 0.2634 ± 0.0202 | 0.1191 ± 0.0247 | 0.2367 ± 0.0034 | 0.0911 ± 0.0020 |
| | 192 | 0.3578 ± 0.0112 | 0.2035 ± 0.0178 | 0.3328 ± 0.0017 | 0.1764 ± 0.0023 |
| | 336 | 0.4953 ± 0.0261 | 0.3834 ± 0.0470 | 0.4445 ± 0.0040 | 0.3025 ± 0.0037 |
| | 720 | 0.7566 ± 0.0738 | 0.8813 ± 0.1297 | 0.7012 ± 0.1039 | 0.7691 ± 0.1976 |
| ILI | 24 | 0.9731 ± 0.0721 | 1.4916 ± 0.2271 | 0.9093 ± 0.0228 | 1.2851 ± 0.0487 |
| | 36 | 0.9572 ± 0.0334 | 1.2017 ± 0.0649 | 0.9048 ± 0.0254 | 1.0860 ± 0.0476 |
| | 48 | 0.9900 ± 0.0174 | 1.1950 ± 0.0306 | 0.9512 ± 0.0244 | 1.1215 ± 0.0385 |
| | 60 | 0.8564 ± 0.0489 | 1.0191 ± 0.0879 | 0.8881 ± 0.0474 | 1.0513 ± 0.0859 |
| Traffic | 96 | 0.4172 ± 0.0194 10 | 0.3331 ± 0.0192 10 | 0.3975 ± 0.0093 10 | 0.3208 ± 0.0125 10 |
| | 192 | 0.2415 ± 0.0010 10 | 0.1613 ± 0.0007 10 | 0.2539 ± 0.0005 10 | 0.1682 ± 0.0004 10 |
| | 336 | 0.2217 ± 0.0001 3 | 0.1378 ± 0.0002 3 | 0.2300 ± 0.0007 2 | 0.1422 ± 0.0002 2 |
| | 720 | 0.2318 ± 0.0020 10 | 0.1443 ± 0.0009 10 | 0.2376 ± 0.0019 10 | 0.1475 ± 0.0011 10 |
| Weather | 96 | 0.0502 ± 0.0127 | 0.0041 ± 0.0017 | 0.0522 ± 0.0059 | 0.0042 ± 0.0007 |
| | 192 | 0.0417 ± 0.0136 | 0.0031 ± 0.0018 | 0.0336 ± 0.0083 | 0.0021 ± 0.0009 |
| | 336 | 0.0281 ± 0.0005 | 0.0015 ± 0.0001 | 0.0281 ± 0.0008 | 0.0015 ± 0.0001 |
| | 720 | 0.0350 ± 0.0007 | 0.0022 ± 0.0002 | 0.0347 ± 0.0009 | 0.0022 ± 0.0002 |

A further example is shown in Table 14, which shows comparison of the disclosed method with DeepTime on univariate forecasting benchmarks on long sequence time-series forecasting. Best results are highlighted in bold, and second best results are underlined.

TABLE 14
Performance Comparison Between the Disclosed
Method and DeepTime on Univariate Forecasting

| | | Methods | | | | | | | | | |
|---|---|---|---|---|---|---|---|---|---|---|---|
| | | DeepRRTime | | DeepTime | | N-HiTS | | ETSformer | | FEDformer | |
| Metrics | | MSE | MAE | MSE | MAE | MSE | MAE | MSE | MAE | MSE | MAE |
| ETTm2 | 96 | 0.071 | 0.192 | 0.072 | 0.194 | 0.066 | 0.185 | 0.080 | 0.212 | 0.063 | 0.189 |
| | 192 | 0.096 | 0.232 | 0.096 | 0.231 | 0.087 | 0.223 | 0.150 | 0.302 | 0.102 | 0.245 |
| | 336 | 0.121 | 0.265 | 0.120 | 0.264 | 0.106 | 0.251 | 0.175 | 0.334 | 0.130 | 0.279 |
| | 720 | 0.177 | 0.327 | 0.178 | 0.328 | 0.157 | 0.312 | 0.224 | 0.379 | 0.178 | 0.325 |
| Exchange | 96 | 0.086 | 0.226 | 0.086 | 0.225 | 0.093 | 0.223 | 0.099 | 0.230 | 0.131 | 0.284 |
| | 192 | 0.174 | 0.329 | 0.174 | 0.331 | 0.230 | 0.313 | 0.223 | 0.353 | 0.277 | 0.420 |
| | 336 | 0.302 | 0.445 | 0.308 | 0.452 | 0.370 | 0.486 | 0.421 | 0.497 | 0.426 | 0.511 |
| | 720 | 0.836 | 0.741 | 0.845 | 0.752 | 0.728 | 0.569 | 1.114 | 0.807 | 1.162 | 0.832 |

| | Methods | | | | | | | | | |
|---|---|---|---|---|---|---|---|---|---|---|
| | N_BEATS | | DeepAR | | Prophet | | ARIMA | | GP | |
| Metrics | MSE | MAE | MSE | MAE | MSE | MAE | MSE | MAE | MSE | MAE |

| | | | | | | | | | | | |
|---|---|---|---|---|---|---|---|---|---|---|---|
| ETTm2 | 96 | 0.082 | 0.219 | 0.099 | 0.237 | 0.287 | 0.456 | 0.211 | 0.362 | 0.125 | 0.273 |
| | 192 | 0.120 | 0.268 | 0.154 | 0.310 | 0.312 | 0.483 | 0.261 | 0.406 | 0.154 | 0.307 |
| | 336 | 0.226 | 0.370 | 0.277 | 0.428 | 0.331 | 0.474 | 0.317 | 0.448 | 0.189 | 0.338 |
| | 720 | 0.188 | 0.338 | 0.332 | 0.468 | 0.534 | 0.593 | 0.366 | 0.487 | 0.318 | 0.421 |
| Exchange | 96 | 0.156 | 0.299 | 0.417 | 0.515 | 0.828 | 0.762 | 0.112 | 0.245 | 0.165 | 0.311 |
| | 192 | 0.669 | 0.665 | 0.813 | 0.735 | 0.909 | 0.974 | 0.304 | 0.404 | 0.649 | 0.617 |
| | 336 | 0.611 | 0.605 | 1.331 | 0.962 | 1.304 | 0.988 | 0.736 | 0.598 | 0.596 | 0.592 |
| | 720 | 1.111 | 0.860 | 1.890 | 1.181 | 3.238 | 1.566 | 1.871 | 0.935 | 1.002 | 0.786 |

In order to investigate improvements over conditioned DeepTime, a 2-layer MLP is jointly trained that takes the lookback-sequence as input and yields a 64-dimensional embedding as output that is concatenated together with the Fourier embedding of the time as the input to the INR. Through this conditioning, DeepTime has the flexibility to output a different basis function in response to changes in lookback sequence. The results are shown in Table 15. Improvements in 37 out of 48 cases are observed with an average improvement of 3.97% MAE and 6.33% MSE. In fact, the highest improvement is observed to go up to 28.36% MAE and 50.08% MSE. These results are also compared with the unconditional DeepTime in Table 16. Overall, 33 of the 48 best results are obtained with regularization while 26 out of 48 best results are obtained with conditioning. Conditioning does not help improve the results in all cases: for example, the conditioning network may overfit to noise prevalent in the Exchange dataset leading to significant degradation in performance.

TABLE 15
Conditioned DeepTime

| | | DeepTime + C | | DeepRRTime + C | |
|---|---|---|---|---|---|
| Data | Forecast | MAE | MSE | MAE | MSE |
| ECL | 96 | 0.2331 ± 0.0011 | 0.1345 ± 0.0009 | 0.2318 ± 0.0005 | 0.1336 ± 0.0003 |
| | 192 | 0.2486 ± 0.0000 | 0.1500 ± 0.0000 | 0.2487 ± 0.0018 | 0.1506 ± 0.0012 |
| | 336 | 0.2658 ± 0.0027 | 0.1633 ± 0.0023 | 0.2637 ± 0.0000 | 0.1615 ± 0.0000 |
| | 720 | 0.3004 ± 0.0000 | 0.1982 ± 0.0000 | 0.2946 ± 0.0000 | 0.1868 ± 0.0000 |
| ETTm2 | 96 | 0.3162 ± 0.0148 | 0.2500 ± 0.0241 | 0.2980 ± 0.0048 | 0.2264 ± 0.0088 |
| | 192 | 0.3565 ± 0.0106 | 0.3341 ± 0.0234 | 0.3201 ± 0.0046 | 0.2532 ± 0.0135 |
| | 336 | 0.4509 ± 0.0306 | 0.4724 ± 0.0699 | 0.3909 ± 0.0132 | 0.3545 ± 0.0178 |
| | 720 | 0.5034 ± 0.0121 | 0.5174 ± 0.0263 | 0.4604 ± 0.0180 | 0.4640 ± 0.0292 |
| Exchange | 96 | 0.3265 ± 0.0733 | 0.2352 ± 0.0961 | 0.2339 ± 0.0484 | 0.1174 ± 0.0597 |
| | 192 | 0.3775 ± 0.0487 | 0.2764 ± 0.0814 | 0.3905 ± 0.0581 | 0.2901 ± 0.0925 |
| | 336 | 0.4352 ± 0.0259 | 0.3368 ± 0.0354 | 0.4311 ± 0.0171 | 0.3416 ± 0.0286 |
| | 720 | 0.6943 ± 0.1006 | 0.9279 ± 0.3177 | 0.6587 ± 0.0804 | 0.8167 ± 0.2061 |
| ILI | 24 | 1.0808 ± 0.0196 | 2.4192 ± 0.0843 | 0.9959 ± 0.0256 | 2.2153 ± 0.0526 |
| | 36 | 1.0228 ± 0.0351 | 2.2233 ± 0.1002 | 0.9695 ± 0.0332 | 2.1313 ± 0.1357 |
| | 48 | 0.9997 ± 0.0221 | 2.1776 ± 0.0562 | 0.9915 ± 0.0277 | 2.1285 ± 0.0670 |
| | 60 | 1.0027 ± 0.0229 | 2.2233 ± 0.0421 | 0.9930 ± 0.0083 | 2.2070 ± 0.0161 |
| Traffic | 96 | 0.2612 ± 0.0045 | 0.3753 ± 0.0061 | 0.2577 ± 0.0000 | 0.3716 ± 0.0000 |
| | 192 | 0.2665 ± 0.0006 | 0.3912 ± 0.0009 | 0.2728 ± 0.0003 | 0.3944 ± 0.0002 |
| | 336 | 0.2809 ± 0.0010 | 0.4112 ± 0.0018 | 0.2800 ± 0.0013 | 0.4109 ± 0.0013 |
| | 720 | 0.3054 ± 0.0009 | 0.4473 ± 0.0007 | 0.2987 ± 0.0003 | 0.4482 ± 0.0008 |
| Weather | 96 | 0.2225 ± 0.0019 | 0.1706 ± 0.0009 | 0.2171 ± 0.0026 | 0.1679 ± 0.0014 |
| | 192 | 0.2626 ± 0.0054 | 0.2117 ± 0.0020 | 0.2629 ± 0.0038 | 0.2128 ± 0.0006 |
| | 336 | 0.2959 ± 0.0049 | 0.2578 ± 0.0017 | 0.2935 ± 0.0005 | 0.2589 ± 0.0004 |
| | 720 | 0.3629 ± 0.0051 | 0.3302 ± 0.0043 | 0.3490 ± 0.0042 | 0.3167 ± 0.0035 |

TABLE 16
DeepTime and DeepTime + C

| | | DeepTime + C | | DeepRRTime + C | | DeepTime | | DeepRRTime | |
|---|---|---|---|---|---|---|---|---|---|
| Data | Forecast | MAE | MSE | MAE | MSE | MAE | MSE | MAE | MSE |
| ECL | 96 | 0.2331 | 0.1345 | 0.2318 | 0.1336 | 0.2384 | 0.1375 | 0.2374 | 0.1369 |
| | 192 | 0.2486 | 0.1500 | 0.2487 | 0.1506 | 0.2515 | 0.1521 | 0.2507 | 0.1517 |
| | 336 | 0.2658 | 0.1633 | 0.2637 | 0.1615 | 0.2679 | 0.1658 | 0.2671 | 0.1655 |
| | 720 | 0.3004 | 0.1982 | 0.2946 | 0.1868 | 0.3018 | 0.2012 | 0.3022 | 0.2016 |
| ETTm2 | 96 | 0.3162 | 0.2500 | 0.2980 | 0.2264 | 0.2582 | 0.1661 | 0.2574 | 0.1655 |
| | 192 | 0.3565 | 0.3341 | 0.3201 | 0.2532 | 0.2974 | 0.2214 | 0.2997 | 0.2252 |
| | 336 | 0.4509 | 0.4724 | 0.3909 | 0.3545 | 0.3365 | 0.2775 | 0.3378 | 0.2789 |
| | 720 | 0.5034 | 0.5174 | 0.4604 | 0.4640 | 0.4054 | 0.3778 | 0.4008 | 0.3699 |
| Exchange | 96 | 0.3265 | 0.2352 | 0.2339 | 0.1174 | 0.1995 | 0.0785 | 0.1950 | 0.0762 |
| | 192 | 0.3775 | 0.2764 | 0.3905 | 0.2901 | 0.2879 | 0.1529 | 0.2856 | 0.1549 |
| | 336 | 0.4352 | 0.3368 | 0.4311 | 0.3416 | 0.4385 | 0.3488 | 0.3777 | 0.2587 |
| | 720 | 0.6943 | 0.9279 | 0.6587 | 0.8167 | 0.6468 | 0.8019 | 0.5640 | 0.5886 |
| ILI | 24 | 1.0808 | 2.4192 | 0.9959 | 2.2153 | 1.1048 | 2.5058 | 1.0211 | 2.2611 |
| | 36 | 1.0228 | 2.2233 | 0.9695 | 2.1313 | 1.0573 | 2.3560 | 1.0325 | 2.3133 |
| | 48 | 0.9997 | 2.1776 | 0.9915 | 2.1285 | 1.0540 | 2.3430 | 1.0279 | 2.2704 |
| | 60 | 1.0027 | 2.2233 | 0.9930 | 2.2070 | 1.0271 | 2.2820 | 1.0326 | 2.2913 |
| Traffic | 96 | 0.2612 | 0.3753 | 0.2577 | 0.3716 | 0.2745 | 0.3903 | 0.2737 | 0.3897 |
| | 192 | 0.2665 | 0.3912 | 0.2728 | 0.3944 | 0.2784 | 0.4019 | 0.2791 | 0.4028 |
| | 336 | 0.2809 | 0.4112 | 0.2800 | 0.4109 | 0.2880 | 0.4154 | 0.2871 | 0.4162 |
| | 720 | 0.3054 | 0.4473 | 0.2987 | 0.4482 | 0.3077 | 0.4505 | 0.3077 | 0.4500 |
| Weather | 96 | 0.2225 | 0.1706 | 0.2171 | 0.1679 | 0.2226 | 0.1662 | 0.2236 | 0.1665 |
| | 192 | 0.2626 | 0.2117 | 0.2629 | 0.2128 | 0.2608 | 0.2072 | 0.2610 | 0.2077 |
| | 336 | 0.2959 | 0.2578 | 0.2935 | 0.2589 | 0.3000 | 0.2514 | 0.2966 | 0.2496 |
| | 720 | 0.3629 | 0.3302 | 0.3490 | 0.3167 | 0.3373 | 0.3004 | 0.3498 | 0.3127 |

Further experiments were conducted to evaluate performance when forecasting at a greater frequency at inference (e.g. every 30 minutes) using an INR network trained to forecast at a smaller frequency (e.g., every hour). The DeepTime model first solves the least-squares optimization problem defined in Equation (1) to compute the optimal parameters W*, b* based on lookback observations; next, the optimal parameters are applied to the basis z_{τ}=f_{θ}(τ) to generate the forecast for the following values of

$$τ : \{ \frac{L}{L + H - 1} , \frac{L + 1}{L + H - 1} , … 1 \} ,$$

where L is the lookback window and H is the forecast horizon. For example, if the INR network is trained over hourly observations, then

$$\frac{1}{L + H - 1}$$

corresponds to a temporal difference of one hour. In order to use the same INR network to generate a forecast at a frequency of 30 minutes, the following sequence of time are indexed instead:

$$\{ \frac{L - 0.5}{L + H - 1} , \frac{L}{L + H - 1} , \frac{L + 1}{L + H - 1} , \frac{L + 0.5}{L + H - 1} , … 1 \} .$$

That is, the temporal interval as represented by τ can be adjusted according to the change in frequency. It should be noted that forecasting at a higher frequency can be referred to as test-time interpolation.

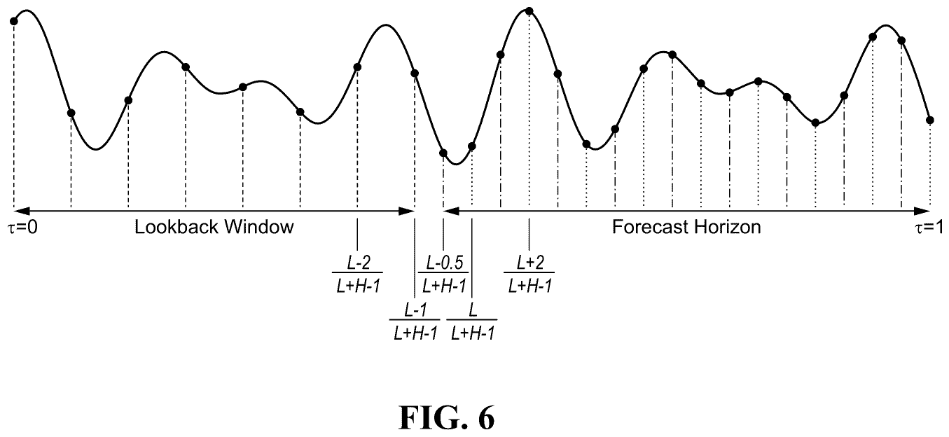

FIG. 6 depicts a visual representation of this change in forecasting frequency. In FIG. 6, test-time interpolation where a time-index model is used to generate forecasts at 2× the frequency it was trained at is shown. During training, the points on the time grid within the lookback window are used to estimate the linear-regression parameters while the points for the dotted lines on the time grid within the forecast horizon are used to compute the training loss. During inference, the flexibility of time-index model can be utilized to interpolate between the training time grid (e.g. points for the dotted lines in the forecast horizon) to forecast at a higher frequency (e.g. points for the dotted and dash-dotted lines in the forecast horizon). Note that the points for the dash-dotted lines within the forecast horizon denote time indexes that are only seen during inference.

More generally, to forecast at an integer frequency ν higher during inference compared to training, it is possible to apply the parameters W*, b* over the basis representation obtained for the following time indices:

$$\{ \frac{v L - 1}{v ( L + H - 1 )} , \frac{v L}{v ( L + H - 1 )} , \frac{v L + 1}{v ( L + H - 1 )} , … 1 \} .$$

Note that this setting interpolates between time indices seen by the network during training and evaluates the network in terms of its ability to generalize to novel time indices seen only during inference.

To evaluate a model trained using the disclosed method in terms of its ability to forecast at a higher frequency, the training data were subsampled at different frequencies, using the ETTm2 dataset with observations spaced 15 minutes apart. For instance, when ν=4, the training data is subsampled to simulate observations at hourly intervals. During inference, forecasts were generated at the original higher frequency (e.g. every 15 minutes). DeepTime and the disclosed method were evaluated on different combinations of ν and forecast horizons H, with μϵ{1, 3, 5, 7, 9} for both DeepTime and the disclosed method and λ₂ϵ{1, 10, 50} for the disclosed method based on the validation loss.

FIG. 2D depicts performance comparisons of the disclosed method and DeepTime on the ETTm2 dataset using MSE plots. The shaded areas show standard deviations over 10 network initializations. Trendlines of DeepTime and the disclosed method are shown as 202 and 204, respectively. As shown in FIG. 2D, the disclosed method achieved significant improvements over DeepTime when forecasting at a frequency that is ν times higher during inference than the frequency observed during training. As such, regularization at block 110 can significantly improves performance across all (ν, H) pairs compared to DeepTime.

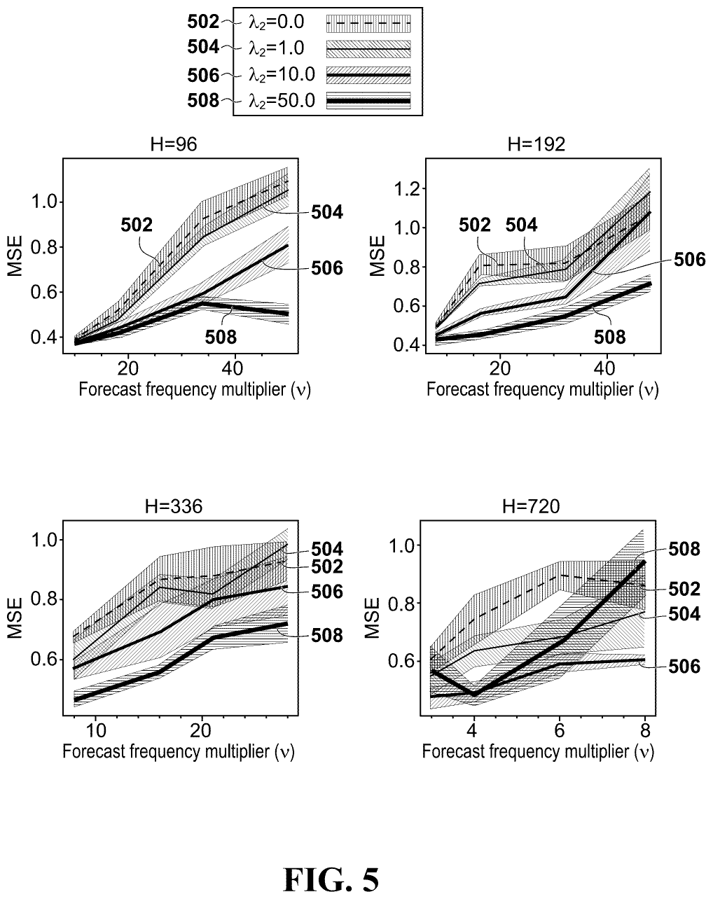

FIG. 5 depicts performances of the disclosed method in forecasting at a higher frequency on the ETTm2 dataset (λ₂=0 corresponds to DeepTime). The shaded areas show standard deviations over 10 network initializations. Trendlines 502, 504, 506, and 208 respectively correspond to λ₂ values of 0, 1, 10, and 50. As seen FIG. 5, the disclosed method achieved significant improvements when forecasting at an integer frequency ν higher during inference as compared the frequency observed during training.

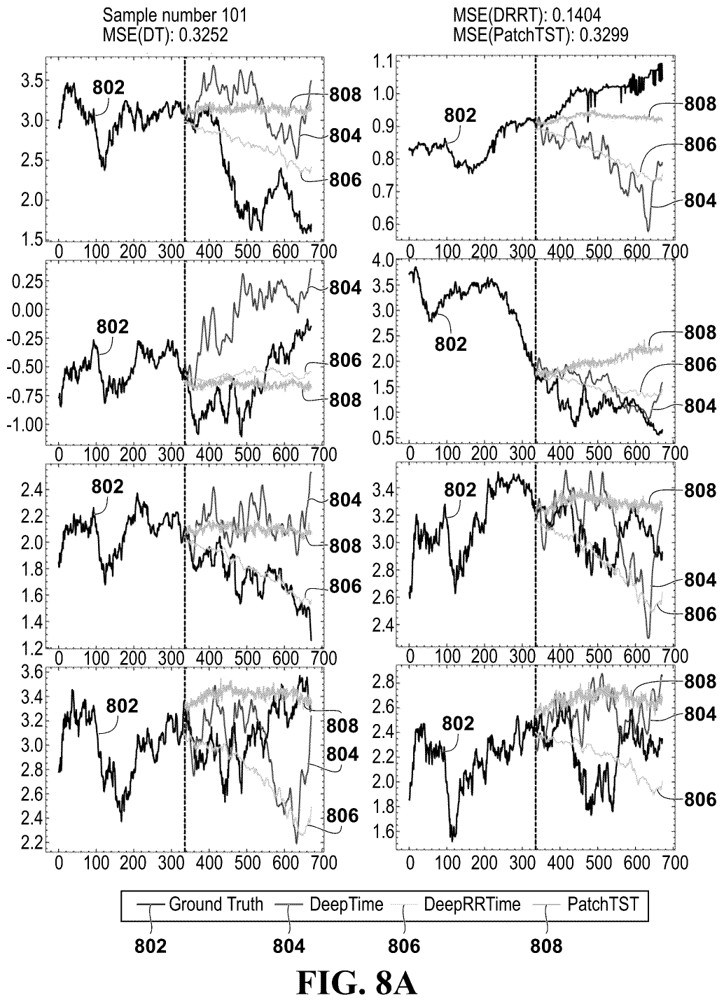

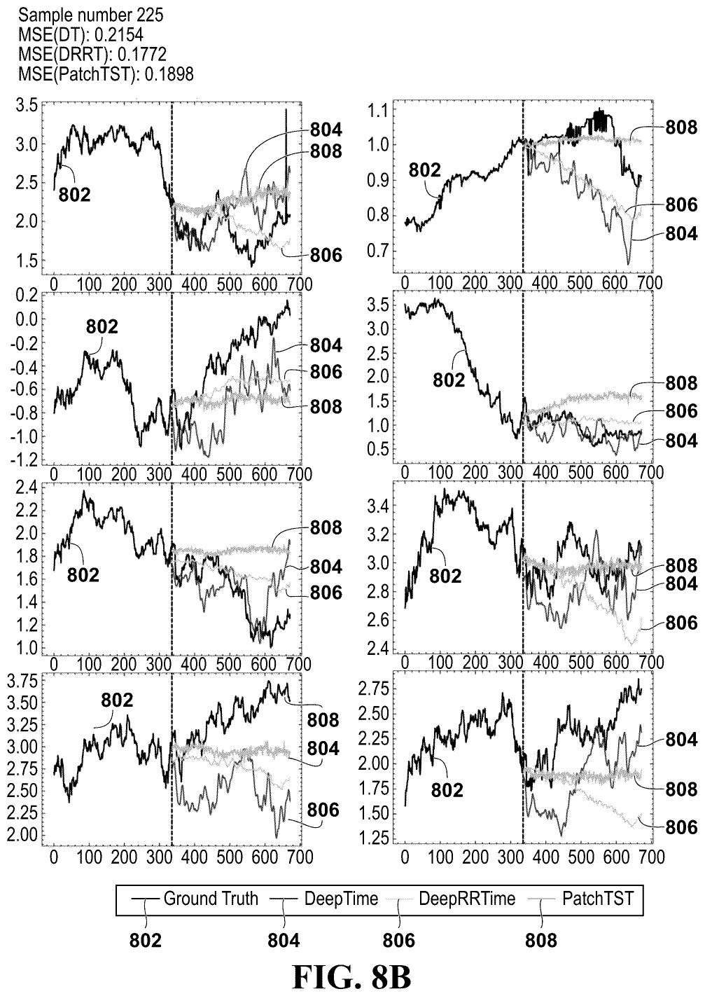

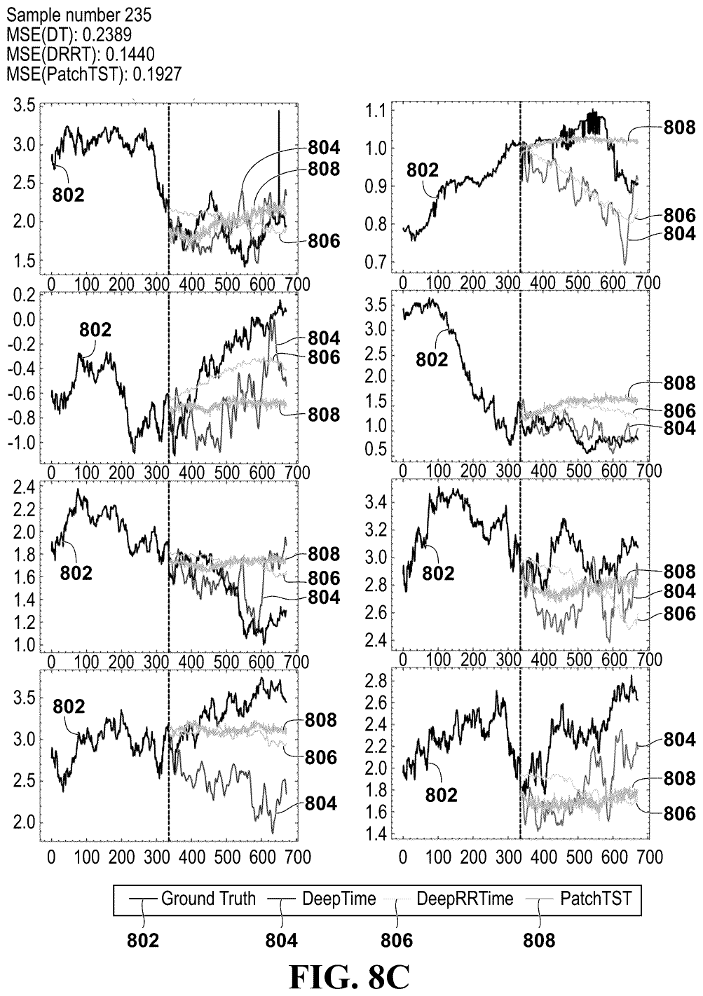

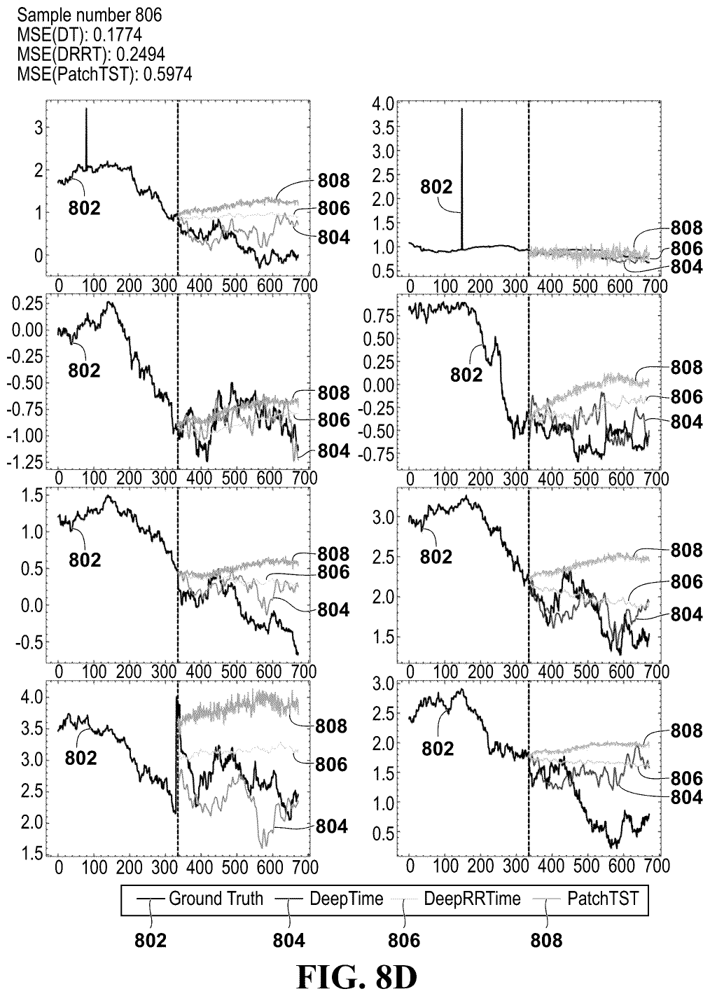

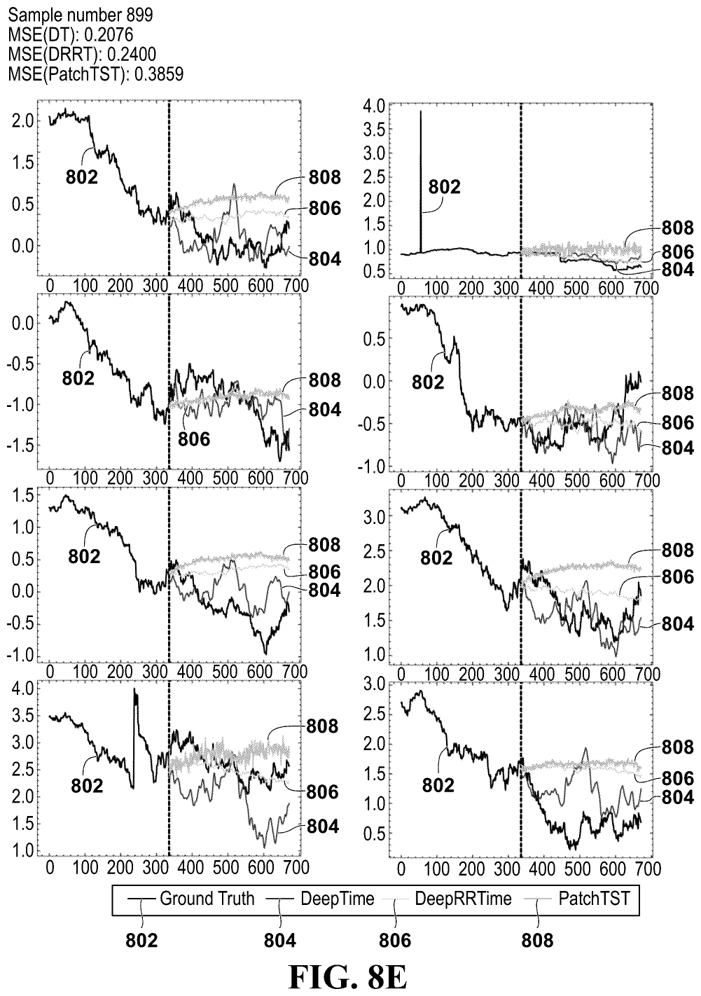

FIGS. 8A-8D depict forecasting plots generated by various models for the Exchange dataset. Each figure comprises 8 different time-variates and all plots within the same figure are taken from the same time-period. The sample-IDs for the visualization are randomly sampled and are as indicated along with the MSE of forecasts for each method. More specifically, the MSE value for each figure is the MSE averaged over all 8 plots in the corresponding figure. The vertical dotted lines correspond to the separation between the lookback region and the horizon region. Ground-truth forecasting plots are annotated as 802. Forecasting plots generated using DeepTime, the disclosed method, and PatchTST are respectively annotated as 804, 806, and 808.

For the above experiments, the disclosed method (method 100) was used to train a standard DeepTime model. The DeepTime model as modified was trained using an Adam optimizer with a learning rate scheduler following a linear warm-up and a cosine annealing scheme. Gradient clipping by norm was used. The ridge regressor regularization coefficient, λ₁, was trained at a higher learning rate compared to the rest of meta parameters. The model was trained with early stopping based on validation loss, with a fixed patience parameter defined as the number of epochs for which the loss can increase before the training is stopped. The ridge regression regularization coefficient parameter were learned and constrained to positive values via a softplus function. ReLU activation, Dropout, and LayerNorm were applied after each INR layer. The dimension of Fourier embedding layer of INR was defined independently of the size of other layers. The total size of the Fourier embedding layer where the number of dimensions for each Fourier frequency scale was computed as the size of the layer divided by the number of scales. Hyperparameters used for the experiments are shown in Table 17.

TABLE 17
Hyperparameters used for Experiments

| | Hyperparameter | Value |
|---|---|---|
| Parameters | Epochs | 50 |
| inherited | Learning rate | 1e−3 |
| from | λ₁ learning rate | 1.0 |
| DeepTime | Warm up epochs | 5 |
| | Batch size | 256 |
| | Early stopping patience | 7 |
| | Max gradient norm | 10.0 |
| | Layer size | 256 |
| | λ₁ initialization | 0.0 |
| | Scales | [0.01, 0.1, 1, 5, |
| | | 10, 20, 50, 100] |
| | Fourier features size | 4096 |
| | INR dropout rate | 0.1 |
| | Lookback length multiplier, μ | μ ∈ {1, 3, 5 7, 9} |
| Our parameters | λ₂ | 1.0 |

The foregoing presents a regularizer to improve time series data forecasting, such as with DeepTime. The advantages of this regularizer are as follows: (1) straightforward to implement; (2) does not alter the overall time-complexity of a single training-step given that DeepTime uses O(n³) operations for the closed-form regression solver; and no new hyperparameters are introduced such as the regularization-strength: in practical applications, fine-tuning the regularization-strength may further improve the results.

An example computer system in respect of which the covariance regularization method 100 described above may be implemented is presented as a block diagram in FIG. 3. The example computer system is denoted generally by reference numeral 300 and includes a display 302, input devices in the form of keyboard 304a and pointing device 304b, computer 306 and external devices 308. While pointing device 304b is depicted as a mouse, it will be appreciated that other types of pointing device, or a touch screen, may also be used.

The computer 306 may contain one or more processors or microprocessors, such as a central processing unit (CPU) 310. The CPU 310 performs arithmetic calculations and control functions to execute software stored in a non-transitory internal memory 312, preferably random access memory (RAM) and/or read only memory (ROM), and possibly additional memory 314. The additional memory 314 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 314 may be physically internal to the computer 306, or external as shown in FIG. 3, or both.

The one or more processors or microprocessors may comprise any suitable processing unit such as an artificial intelligence accelerator, programmable logic controller, a microcontroller (which comprises both a processing unit and a non-transitory computer readable medium), AI accelerator, system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal and/or additional memory 314 for execution by the one or more processors or microprocessors to effect neural network pre-training, training, or use of a trained network for inference.

The computer system 300 may also include other similar means for allowing computer programs or other instructions to be loaded. Such means can include, for example, a communications interface 316 which allows software and data to be transferred between the computer system 300 and external systems and networks. Examples of communications interface 316 can include a modem, a network interface such as an Ethernet card, a wireless communication interface, or a serial or parallel communications port. Software and data transferred via communications interface 316 are in the form of signals which can be electronic, acoustic, electromagnetic, optical or other signals capable of being received by communications interface 316. Multiple interfaces, of course, can be provided on a single computer system 300.

Input and output to and from the computer 306 is administered by the input/output (I/O) interface 318. This I/O interface 318 administers control of the display 302, keyboard 304a, external devices 308 and other such components of the computer system 300. The computer 306 also includes a graphical processing unit (GPU) 320. The latter may also be used for computational purposes as an adjunct to, or instead of, the CPU 310, for mathematical calculations.

The external devices 308 include a microphone 326, a speaker 328 and a camera 330. Although shown as external devices, they may alternatively be built in as part of the hardware of the computer system 300.

The various components of the computer system 300 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a file” or “the file” does not exclude embodiments in which multiple files are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present. The term “or” is generally employed in its sense including “and/or” unless the content clearly dictates otherwise.

It is contemplated that any part of any aspect or embodiment discussed in this specification can be implemented or combined with any part of any other aspect or embodiment discussed in this specification, so long as such implementation or combination is not performed using mutually exclusive parts.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### REFERENCES

[1] Smyl, S. A hybrid method of exponential smoothing and recurrent neural networks for time series forecasting. International Journal of Forecasting, 360 (1):0 75-85, 2020.
[2] Oreshkin, B. N., Carpov, D., Chapados, N., and Bengio, Y. N-beats: Neural basis expansion analysis for interpretable time series forecasting. In International Conference on Learning Representations, 2019.
[3] Challu, C., Olivares, K. G., Oreshkin, B. N., Ramirez, F. G., Canseco, M. M., and Dubrawski, A. Nhits: Neural hierarchical interpolation for time series forecasting. In Proceedings of the AAAI Conference on Artificial Intelligence, volume 37, pp. 6989-6997, 2023.
[4] Zhou, H., Zhang, S., Peng, J., Zhang, S., Li, J., Xiong, H., and Zhang, W. Informer: Beyond efficient transformer for long sequence time-series forecasting. In Proceedings of the AAAI conference on artificial intelligence, volume 35, pp. 11106-11115, 2021.
[5] Wu, H., Xu, J., Wang, J., and Long, M. Autoformer: Decomposition transformers with auto-correlation for long-term series forecasting. Advances in Neural Information Processing Systems, 34:0 22419-22430, 2021.
[6] Zhou, T., Ma, Z., Wen, Q., Wang, X., Sun, L., and Jin, R. Fedformer: Frequency enhanced decomposed transformer for long-term series forecasting. In International Conference on Machine Learning, pp. 27268-27286. PMLR, 2022.
[7] Nie, Y., Nguyen, N. H., Sinthong, P., and Kalagnanam, J. A time series is worth 64 words: Long-term forecasting with transformers. In International Conference on Learning Representations, 2023.
[8] Wang, J., Lan, C., Liu, C., Ouyang, Y., Qin, T., Lu, W., Chen, Y., Zeng, W., and Yu, P. Generalizing to unseen domains: A survey on domain generalization. IEEE Transactions on Knowledge and Data Engineering, 2022.
[9] Wang, J., Feng, W., Chen, Y., Yu, H., Huang, M., and Yu, P. S. Visual domain adaptation with manifold embedded distribution alignment. In Proceedings of the 26th ACM international conference on Multimedia, pp. 402-410, 2018.
[10] Zhang, M., Levine, S., and Finn, C. Memo: Test time robustness via adaptation and augmentation. Advances in Neural Information Processing Systems, 35:0 38629-38642, 2022.

[11] Bartler, A., Bühler, A., Wiewel, F., Döbler, M., and Yang, B. Mt3: Meta test-time training for self-supervised test-time adaption. In International Conference on Artificial Intelligence and Statistics, pp. 3080-3090. PMLR, 2022.
[12] Du, Y., Wang, J., Feng, W., Pan, S., Qin, T., Xu, R., and Wang, C. Adarnn: Adaptive learning and forecasting of time series. In Proceedings of the 30th ACM international conference on information & knowledge management, pp. 402-411, 2021.
[13] Kim, T., Kim, J., Tae, Y., Park, C., Choi, J.-H., and Choo, J. Reversible instance normalization for accurate time-series forecasting against distribution shift. In International Conference on Learning Representations, 2021.
[14] Liu, Y., Wu, H., Wang, J., and Long, M. Non-stationary transformers: Exploring the stationarity in time series forecasting. In Oh, A. H., Agarwal, A., Belgrave, D., and Cho, K. (eds.), Advances in Neural Information Processing Systems, 2022b. URL https://openreview.net/forum?id=ucNDIDRNjjv.
[15] Woo, G., Liu, C., Sahoo, D., Kumar, A., and Hoi, S. Learning deep time-index models for time series forecasting. In International Conference on Machine Learning, pp. 37217-37237. PMLR, 2023.
[16] Finn, C., Abbeel, P., and Levine, S. Model-agnostic meta-learning for fast adaptation of deep networks. In International conference on machine learning, pp. 1126-1135. PMLR, 2017.
[17] Nichol, A., Achiam, J., and Schulman, J. On first-order meta-learning algorithms. arXiv preprint arXiv:1803.02999, 2018.
[18] Raghu, A., Raghu, M., Bengio, S., and Vinyals, O. Rapid learning or feature reuse?towards understanding the effectiveness of maml. International Conference on Learning Representations, 2020.
[19] Bertinetto, L., Henriques, J., Torr, P., and Vedaldi, A. Meta-learning with differentiable closed-form solvers. In International Conference on Learning Representations (ICLR), 2019. International Conference on Learning Representations, 2019.
[20] Krikheli, M. and Leshem, A. Finite sample performance of linear least squares estimation. Journal of the Franklin Institute, 3580 (15):0 7955-7991, 2021. ISSN 0016-0032. doi:https://doi.org/10.1016/j.jfranklin.2021.07.048. URL https://www.sciencedirect.com/science/article/pii/S0016003221004506.
[21] Hermann Weyl. Das asymptotische verteilungsgesetz der eigenwerte linearer partieller differentialgleichungen (mit einer anwendung auf die theorie der hohlraumstrahlung). Mathematische Annalen, 71(4):441-479, 1912. doi: 10.1007/BF01456804. URL https://doi.org/10.1007/BF01456804.
[22] S Gershgorin. Uber die abgrenzung der eigenwerte einer matrix. lzv. Akad. Nauk. USSR. Otd. Fiz-Mat. Nauk, 7:749-754, 1931.

1. A method for training an implicit neural representation (INR) network to perform time series data forecasting, the method comprising:
(a) obtaining a lookback time series of data and a horizon time series of data, wherein the lookback time series of data spans a lookback time window and the horizon time series of data spans a horizon time window following the lookback time window, wherein each of the series of data comprises time and corresponding sample values;
(b) determining a lookback basis and a horizon basis by processing the lookback time series of data using the INR network;
(c) determining weight and bias parameters using a regression based on the lookback basis and the lookback time series;
(d) forecasting predicted horizon values from the horizon basis values and the weight and bias parameters; and
(e) training the INR network to reduce forecast error between the horizon time series of data and the predicted horizon values, wherein the training comprises penalizing linear redundancies between pairs of bases selected from the lookback and horizon bases.

2. The method of claim 1, wherein the penalizing is performed by applying a covariance regularization.

3. The method of claim 2, wherein applying the covariance regularization comprises adding a covariance regularization term to an objective function used to reduce the forecast error during the training of the INR network.

4. The method of claim 3, wherein the objective function comprises forecasting loss and the covariance regularization term.

5. The method of claim 3, wherein the covariance regularization term comprises a covariance matrix, wherein elements of the covariance matrix represent covariances between the elements of the lookback and horizon bases.

6. The method of claim 5, wherein the covariance matrix is a centered covariance matrix.

7. The method of claim 5, wherein the covariance matrix is expressed as
$${G}_{θ} ( i j ) = \frac{1}{L + H} {\sum }_{τ ∈ \{ 0 , \frac{1}{L + H} … 1 \}} ( {z}_{τ}^{i} - {μ}^{i} ) , where {μ}^{i} = \frac{1}{L + H} {\sum }_{τ} {z}_{τ}^{i} ,$$
where L is a lookback length, H is a forecast horizon, r is a time index, and z is a basis.

8. The method of claim 6, wherein off-diagonal elements of the covariance matrix are regularized towards zero, and diagonal elements of the covariance matrix are regularized towards one.

9. The method of claim 8, wherein the covariance regularization term is
$${ℒ}_{C o v} ( θ ) = \frac{1}{{D}^{2}} [ {\sum }_{1 \leq i \neq j \leq D} {{G}_{i j} ( θ )}^{2} + {\sum }_{1 \leq i \leq D} {( {G}_{i i} ( θ ) - 1 )}^{2} ] ,$$
where D is a basis dimension and θ is a network parameter.

10. The method of claim 9, wherein the objective function is arg min_{θ}∥Y_{H}− [symbol] (θ,W*(θ), b*(θ))∥₂²+λ₂ [symbol] _{Cov}(θ), where Y_{H} is ground-truth, [symbol] is predicted horizon values, W* is a weight parameter, b* is a bias parameter, and λ₂ is a covariance regularization coefficient.

11. The method of claim 10, wherein λ₂ equals 1.

12. The method of claim 1, wherein the lookback and horizon time series of data are non-stationary.

13. The method of claim 1, wherein the lookback and horizon time series of data are noisy.

14. The method of claim 1, wherein the regression is a ridge regression.

15. The method of claim 1, wherein variances between the pairs of bases are regularized towards 1 while penalizing the linear redundancies.

16. The method of claim 1, wherein the lookback series of data is non-uniformly sampled in time to perform the time series data forecasting at a higher frequency.

17. The method of claim 1, further comprising performing the time series data forecasting by processing time series data with the INR network to generate one or more forecasts.

18. A method for performing time series data forecasting, comprising:
(a) processing time series data with an implicit neural representation (INR) network to generate one or more forecasts, the INR network trained by:
(i) obtaining a lookback time series of data and a horizon time series of data, wherein the lookback time series of data spans a lookback time window and the horizon time series of data spans a horizon time window following the lookback time window, wherein each of the series of data comprises time and corresponding sample values;
(ii) determining a lookback basis and a horizon basis by processing the lookback time series of data using the INR network;
(iii) determining weight and bias parameters using a regression based on the lookback basis and the lookback time series;
(iv) forecasting predicted horizon values from the horizon basis values and the weight and bias parameters; and
(v) training the INR network to reduce forecast error between the horizon time series of data and the predicted horizon values, wherein the training comprises penalizing linear redundancies between pairs of bases selected from the lookback and horizon bases.

19. A system for training an implicit neural representation (INR) network to perform time series data forecasting, the system comprising:
(a) at least one database having stored therein a lookback time series of data and a horizon time series of data, wherein the lookback time series of data spans a lookback time window and the horizon time series of data spans a horizon time window later in time than the lookback time window;
(b) at least one processor communicatively coupled with the at least one database; and
(c) at least one memory communicatively coupled to the at least one processor, the at least one memory having stored thereon computer program code that is executable by the at least one processor and that, when executed by the at least one processor, causes the at least one processor to perform a method comprising:
(i) obtaining a lookback time series of data and a horizon time series of data, wherein the lookback time series of data spans a lookback time window and the horizon time series of data spans a horizon time window following the lookback time window, wherein each of the series of data comprises time and corresponding sample values;
(ii) determining a lookback basis and a horizon basis by processing the lookback time series of data using the INR network;
(iii) determining weight and bias parameters using a regression based on the lookback basis and the lookback time series;
(iv) forecasting predicted horizon values from the horizon basis values and the weight and bias parameters; and
(v) training the INR network to reduce forecast error between the horizon time series of data and the predicted horizon values, wherein the training comprises penalizing linear redundancies between pairs of bases selected from the lookback and horizon bases.

20. At least one non-transitory computer readable medium having stored thereon computer program code that is executable by at least one processor and that, when executed by the at least one processor, causes the at least one processor to perform a method comprising:
(a) obtaining a lookback time series of data and a horizon time series of data, wherein the lookback time series of data spans a lookback time window and the horizon time series of data spans a horizon time window following the lookback time window, wherein each of the series of data comprises time and corresponding sample values;
(b) determining a lookback basis and a horizon basis by processing the lookback time series of data using the INR network;
(c) determining weight and bias parameters using a regression based on the lookback basis and the lookback time series;
(d) forecasting predicted horizon values from the horizon basis values and the weight and bias parameters; and
(e) training the INR network to reduce forecast error between the horizon time series of data and the predicted horizon values, wherein the training comprises penalizing linear redundancies between pairs of bases selected from the lookback and horizon bases.
